(19) United States
(12) Patent Application Publication
(10) Pub. No.: US 2021/0322963 A1
(43) Pub. Date: Oct. 21, 2021

(54) ORGANIC POLYMERS AS PHOTOCATALYSTS

(71) Applicant: UNIVERSITY OF LOUISVILLE RESEARCH FOUNDATION, Louisville, KY (US)

(72) Inventors: Sachin HANDA, Louisville, KY (US); Justin SMITH, Louisville, KY (US)

(21) Appl. No.: 17/271,047

(22) PCT Filed: Aug. 28, 2019
(86) PCT No.: PCT/US2019/048486

§ 371 Date: Feb. 24, 2021

Related U.S. Application Data
(60) Provisional application No. 62/723,697, filed on Aug. 28, 2018.

(51) Int. Cl. B01J 35/00; C08L 71/00; B01J 31/06; B01J 37/02

(52) U.S. Cl. CPC B01J 35/004; B01J 37/0219; B01J 31/06; C08L 71/00

(57) ABSTRACT

Organopolymers and their use in a backside irradiation system or front side irradiation system and method is provided. A reaction system includes a photocatalyst coating comprising non-conjugatively linked chromophores having a first surface adhered to a substrate, and second surface facing a volume, wherein the volume is configured to contain or pass over the second surface of the photocatalyst coating facing the volume one or more reactants. A source of electromagnetic radiation directs electromagnetic radiation either i) through said substrate and said coating of said photocatalyst to catalyze a reaction of said one or more reactants (backside irradiation), or ii) through said volume to said coating of said photocatalyst to catalyze the reaction of said one or more reactants (frontsi de irradiation).

### FIELD OF THE INVENTION

The invention is generally related to organopolymer photocatalysts and applications thereof.

### BACKGROUND OF THE INVENTION

Compared to heterogeneous photocatalysts involving organometallic complexes or nanomaterials, the more sustainable alternative of heterogeneous organophotocatalsts is underexplored¹. Heterogenization of small-molecule organophotocatalysts has previously been accomplished by adsorption onto heterogeneous material², entrapment within a heterogeneous matrix^{2c,3}, and covalent attachment to heterogeneous material⁴.

Long valued for their various material properties⁵, π-conjugated organopolymers are well known, but their use as macromolecular photocatalysts (MPCs) in metal-free photochemical synthetic transformations has only recently begun to gain attention. The use of such polymers in MPC composites with semiconductor materials is more common but also still relatively recent⁷.

Polymer MPCs where the desired photocatalytic activity is imparted by tethered pendant groups are known⁸, but linear polymers which concurrently provide solution processability, porosity, and a fixed proximity of non-conjugatively linked chromophoric motifs are lacking. The archetypal polymer of intrinsic microporosity, PIM-1 , was first reported in 2004 by Budd et al.¹⁴ (see U.S. Pat. No. 7,690,514 incorporated herein by reference) as a fluorescent yellow double-strand polymer prepared from a reaction of tetrafluoroterephthalonitrile and a tetrahydroxyspirobiindane. However, PIM-1 has not been described as having any photocatalyst activity. A variety of reports have appeared documenting the modular tunability of PIM-1 properties through nitrile derivatization or co-incorporation of different monomers, especially for the purpose of changing the gas permeability of the resultant analog^{17,18.}

Improved organopolymer MPCs that are suitable for homogenous and heterogeneous photoredox catalysis are needed.

### SUMMARY OF THE INVENTION

An aspect of the present disclosure provides solution-processable organopolymer photocatalysts that can effectively facilitate reactions when positioned between the source of irradiation and the reaction mixture. This irradiation configuration is referred to herein as “backside irradiation”. Compared to prior technology, the disclosed catalysts are more sustainable (metal-free, easily recyclable), more easily handled (do not decompose in the presence of oxygen or water, are solution-processable), avoid contamination of reaction products, and are highly tunable (absorption wavelength, reduction potential, solubility, macromolecular structure). Benchmarking against common organophotoredox catalysts indicates that the disclosed catalysts are more than five times as effective as the nearest competitor. The catalysts can be efficiently recovered and reused, and are effective when employed as a wall-coating in flow and batch reaction modes with backside irradiation, even with opaque reaction mixtures.

Embodiments of the present disclosure provide a reaction system comprising a photocatalyst coating comprising non-conjugatively linked chromophores having a first surface adhered to a substrate, and second surface facing a volume, wherein the volume is configured to contain or pass over the second surface of the photocatalyst coating facing the volume one or more reactants; and a source of electromagnetic radiation which directs electromagnetic radiation either i) through said substrate and said coating of said photocatalyst to catalyze a reaction of said one or more reactants, or ii) through said volume to said coating of said photocatalyst to catalyze said reaction of said one or more reactants.

Further embodiments of the present disclosure provide a method of catalyzing a reaction, comprising exposing one or more reactants to a surface of a photocatalyst comprising non-conjugatively linked chromophores coated on a substrate; and directing electromagnetic radiation either i) through said substrate and said coating of said photocatalyst to catalyze a reaction of said one or more reactants, or ii) through said volume to said coating of said photocatalyst to catalyze said reaction of said one or more reactants.

In some embodiments, the photocatalyst comprises at least one chromophore having a sulfone or sulfur-containing cyclic moiety. In some embodiments, the photocatalyst comprises at least one chromophore having a phenothiazine, phenoxazine, or an N-Aryl (5,10-dihydrophenazine derivative) group. In some embodiments, the photocatalyst comprises at least two different chromophores. In some embodiments, the substrate is a surface of, or is inserted into, a continuous flow reactor or a batch reactor. In some embodiments, the source of electromagnetic radiation comprises one or more of a semiconductor optical source, a light-emitting diode optical source, a compact fluorescent light source, an ultraviolet optical source, and a deep-ultraviolet optical source. In some embodiments, the photocatalyst is employed in a photoredox process or in a photosensitization process.

### BRIEF DESCRIPTION OF THE DRAWINGS

FIGS. 1A-D. Structure and application of organopolymer photocatalyst MPC-1. (A) Constituent monomers and representative structure of MPC-1. The polymer is prepared by nucleophilic aromatic substitution, and chromophore subunits are randomly distributed. MPC-1 is an analog of PIM-1 , which lacks sulfone monomer 3. (B) α-Halocarbonyl compound hydrodehalogenation model reaction used to demonstrate the efficacy and advantages of MPC-1. (C) Processability of MPC-1 and its application. Preparations of MPC-1 have been cast into thin-film thimbles and applied as a coating to reaction vessels. (D) MPC-1 ideal constitutional unit and hydrodehalogenation reaction of α-keto bromide 4a underwent hydrodehalogenation in the presence of HE reductant, 1 mol % MPC-1-0 (based on the molecular weight of the constitutional unit of an ideal regular polymer), and blue LED irradiation.

FIG. 2. α-Halocarbonyl compound hydrodehalogenation scope with MPC-1-1. Conditions (unless otherwise noted): halide 4 (0.25 mmol), MPC-1-1 (1 mol %, approximated as 1529 g mol⁻¹), HE (0.375 mmol), acetone (0.5 mL, argon-sparged), argon atmosphere, 10×75-mm borosilicate test tube (spin-vane-equipped, septum/PTFE-tape-sealed), blue LED irradiation, 37° C. Gram-scale reaction conditions: 4b (5.0 mmol), MPC-1-1 (0.2 mol %), HE (10.0 mmol), acetone (10.0 mL, argon-sparged), argon atmosphere, 2.5 mL round-bottom flask (stir-bar-equipped, septurniPTFE-tape-sealed), blue LED irradiation, 37° C., 24 h. Reported yields are isolated. ^{b}1.0 mL acetone and 2 mot % MPC-1-1 were used. ^{c}MPC-1-0 was used as the catalyst. ¹3.0 equiv of HE was used, and both bromides were reduced.

FIGS. 3A-H. Characterization of MPC-1 preparations and assessment of catalytic activity. (A)¹H NMR of MPC-1-2 with peak labels corresponding to proton locations. (B) Tabulated gel permeation chromatography (GPC) results; PDI polydispersity index. (C) GPC chromatograms. (D) Mark-Houwink plots of MPC-1 preparations. (E) Scanning electron microscopy (SEM) image of a sheet of MPC-1-2. (F) High-resolution transmission electron microscopy (HRTEM) images of MPC-1-1 and MPC-1-2. (G) MPC-lactivity studies: isolated yields of model substrates with MPC-1-1 and MPC-1-2, comparison of MPC-1-2 fractionations in chloroform, and comparison with benchmarking catalysts; PTH=10-phenylphenothiazine; PDI=N,N-bis(2,6-diisopropylphenyl)perylene-3,4,9,10-bis(dicarboximide). (H) MPC-1-2 efficacy with hydrodehalogenation of a less reactive substrate and deprotection of a brominated ene-aldehyde.

FIGS. 4A-B. Batch and flow recyclability of MPC-1-2. (A) Recycle study with MPC-1-2_{LMW}. Each recycle, additional 4b (0.25 mmol) and HE (0.375 mmol) were added to the recovered MPC-1-2_{LMW} catalyst (1 mol %, approximated as 1529 g mol⁻¹) originating from the zeroth cycle; the reaction vessel was sealed, thrice evacuated/argon-backfilled, filled with 0.5 mL argon-sparged acetone, then stirred at 37° C. under blue LED irradiation for 3 h. MPC-1-2_{LMW} was recovered by diluting the reaction mixture with 0.5 mL methanol and passing it through a fritted glass funnel; the catalyst was then returned to the reaction vessel by spatula or by passing it through the frit with dichloromethane. (B) Flow chemistry with MPC-1-2_{HMW} as a thin-film coating. Reaction conditions: 4b (0.7 mmol, placed in the reservoir), HE (1.05 mmol, placed in the reactor cell), acetonitrile (3.5 mL, argon-sparged), argon atmosphere, peristaltic circulation through an MPC-1-2_{HMW}-coated (2.5 mol %) reactor cell under blue LED irradiation, 37° C., 26 h.

FIGS. 5A-D. Investigation of mechanism and viability of backside irradiation. (A) Mechanism. (B) Activity screening of polymer subunit models; all models were prepared as mixtures of isomers. (C) Illustration of backside irradiation vs. frontside irradiation, (D) Results of charcoal occlusion study for coatings and suspensions of MPC-1-2_{HMW}.

FIG. 6A-D. Structures of (A) polymeric photocatalysts and (B,C,D) example chromophore motifs according to some embodiments of the disclosure.

FIGS. 7A-B, (A) Backside and (B) frontside irradiation reactor set-up utilizing a photocatalyst coated on a substrate inserted into a reaction mixture containing one or more reactants according to some embodiments of the disclosure.

FIG. 8. Example monomers for non-conjugative linkage of chromophores according to some embodiments of the disclosure.

FIG. 9. Example functional groups which may enhance glass adhesion according to some embodiments of the disclosure.

FIG. 10. Examples of adhesion-promoting functional group incorporation at the monomer stage according to some embodiments of the disclosure.

FIG. 11A-E. Examples of post-functionalization for adhesion enhancement according to some embodiments of the disclosure. (A) Example of silane incorporation by post-functionalization of an alkene monomer, (B) Example of MPC nucleophile deprotection for subsequent post-functionalization. (C) Example electrophiles for reaction with MPC nucleophiles. (D) Example of MPC electrophile generation for subsequent post-functionalization. (E) Example nucleophiles for reaction with MPC electrophiles.

### DETAILED DESCRIPTION

For the purposes of the present disclosure, the terms “compound,” “PIM-1 analog,” and “organopolymer MPC” stand equally well for the inventive compounds described herein, including all enantiomeric forms, diastereomeric forms, salts, and the like. Compounds described herein can contain an asymmetric atom (also referred as a chiral center), and some of the compounds can contain one or more asymmetric atoms or centers, which can thus give rise to optical isomers (enantiomers) and diastereomers. The present teachings and compounds disclosed herein include such enantiomers and diastereomers, as well as the racemic and resolved, enantiomerically pure R and S stereoisomers, as well as other mixtures of the R and S stereoisomers and salts thereof. Optical isomers can be obtained in pure form by standard procedures known to those skilled in the art, which include, but are not limited to, diastereomeric salt formation, kinetic resolution, and asymmetric synthesis. The present teachings also encompass cis and trans isomers of compounds containing alkenyl moieties alkenes and imines). It is also understood that the present teachings encompass all possible regioisomers, and mixtures thereof, which can be obtained in pure form by standard separation procedures known to those skilled in the art, and include, but are not limited to, column chromatography, thin-layer chromatography, and high-performance liquid chromatography.

The term “photocatalyst” refers to compounds with the ability to undergo a reduction-oxidation (“redox”) reaction in the excited state (also referred to as a photoredox catalyst). The catalyst absorbs light and enters into an “excited state”; the excited-state catalyst then undergoes a redox reaction with another molecule, meaning that an electron is transferred to or from the catalyst. A subsequent turnover step can enable participation in light-driven catalytic redox cycles. The terms encompass both photoredox and energy transfer reaction mechanisms. In some embodiments, the compounds described herein also act as photosensitizers.

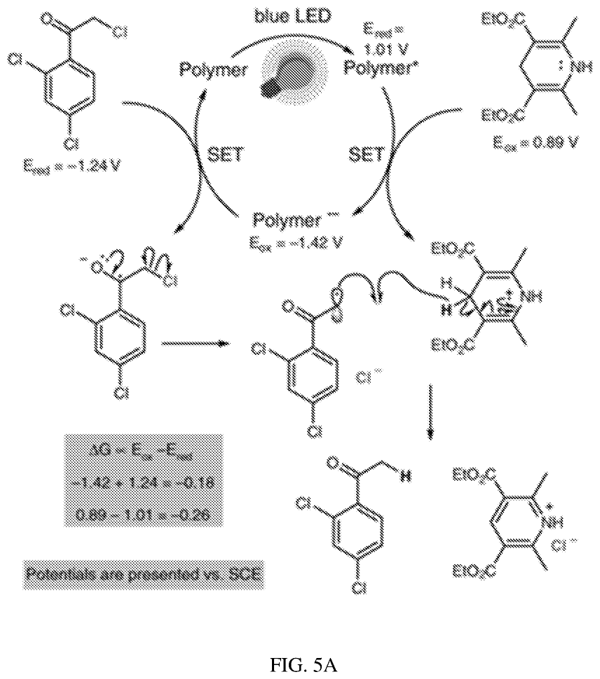

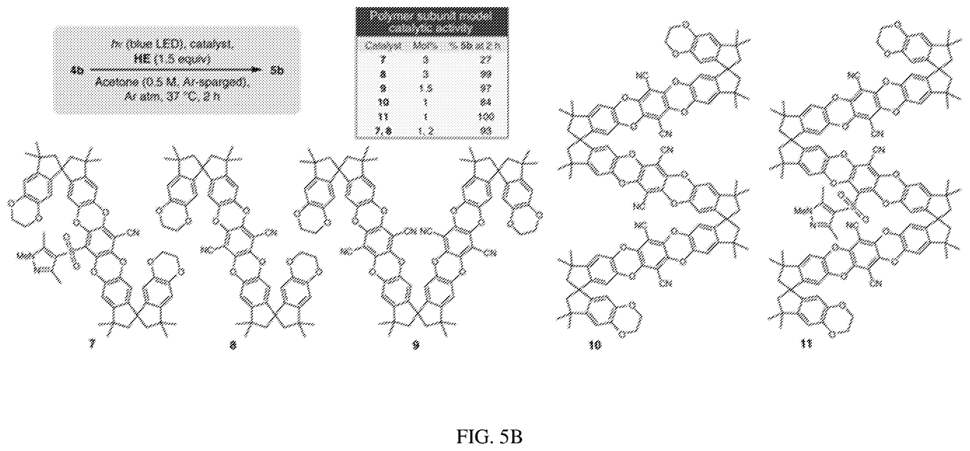

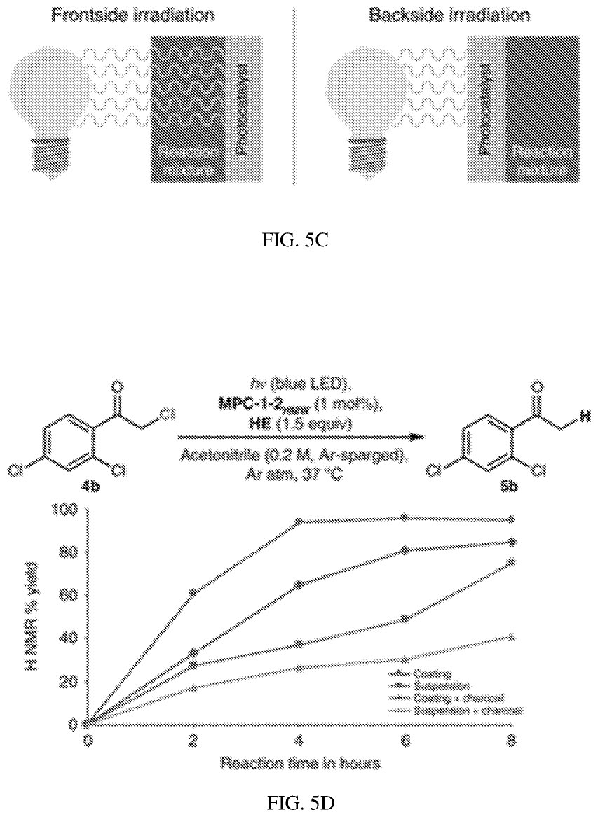

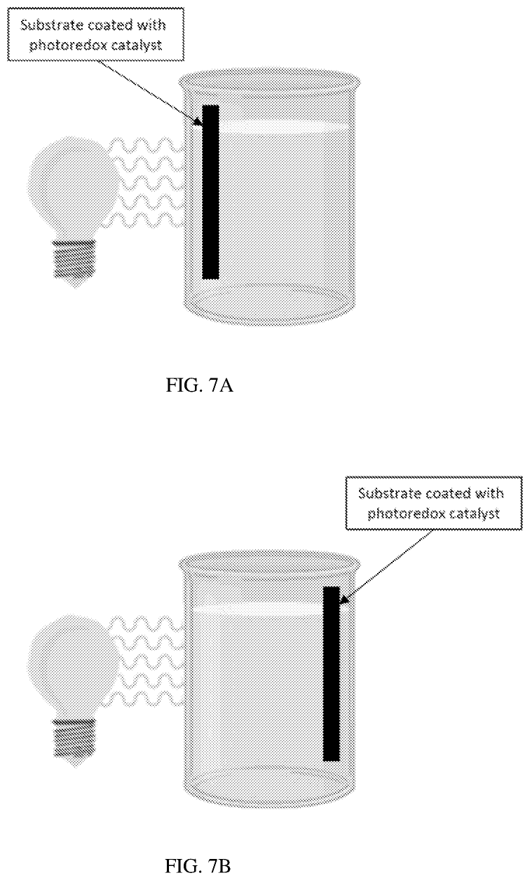

Embodiments of the disclosure provide systems and methods for backside or frontside irradiation in which a photocatalyst is coated on a vessel wall or a substrate inserted into a vessel (e.g. see FIGS. 5C and 7A-B). Backside irradiation allows for the irradiation of a photocatalyst on a face that is not in contact with the reaction mixture which may be a fluid or gas. Backside irradiation is particularly useful when reaction conditions inhibit the transmission of irradiation through the reaction mixture or when a product is formed (such as a polymer) which changes the extent of catalyst irradiation through partially blocking the irradiation. In the latter case, the formation of polymers with greater control over the irradiation is possible. The ability to use backside irradiation also greatly simplifies the preparation of heterogeneous catalyst reactors since the catalyst can be applied as a simple coating over the entirety of the surface to be irradiated; it is not necessary to create a “window” in the catalyst layer to let the irradiation in.

Embodiments of the present disclosure provide a photo-initiated reaction system comprising a photocatalyst coating comprising non-conjugatively linked chromophores having a first surface adhered to a substrate, and second surface facing a volume, wherein the volume is configured to contain or pass over the second surface of the photocatalyst coating facing the volume one or more reactants; and a source of electromagnetic radiation which directs electromagnetic radiation either i) through said substrate and said coating of said photocatalyst to catalyze a reaction of said one or more reactants, or ii) through said volume to said coating of said photocatalyst to catalyze said reaction of said one or more reactants.

Some aspects of the disclosure provide a continuous flow reactor or batch reactor pre-coated kith a photocatalyst as described herein (i.e. the vessel wall is the substrate). A continuous flow reactor carries material as a flowing stream in which reactants are continuously fed into the reactor and emerge as a continuous stream of product. In some embodiments, reactants are recycled two or more times through the flow reactor. Batch reactors are tanks that are large enough to handle the inventory of a complete batch cycle. In some embodiments, the tanks are stirred or otherwise agitated, such as via a reflux mechanism. In some embodiments, the photocatalyst is disposed on at least a portion of the interior surface of the reactor that is nearest to the irradiation source. In some embodiments, the photocatalyst is disposed on substantially the entire interior surface of the reactor.

In some embodiments, the photocatalyst is not coated on a wall or surface of the reactor vessel but is coated on “curtain” substrate or “probe” substrate that is placed into the reaction vessel. For example, a probe-like substrate may comprise a tube containing a light in source such as a fiberoptic cable sealed at the end with a photocatalyst-coated plug, e.g. a glass plug. In some embodiments, the substrate is comprised of glass or other transparent material. In some embodiments, the substrate is non-transparent. The substrate may be placed close to or adjacent to the portion of the vessel wall that is nearest to the irradiation source.

The term “transparent” refers to a material that allows at least some light to pass through. For example, during backside irradiation, light from the radiation source passes through the transparent substrate (e.g. a vessel wall or curtain) and photocatalyst to reach the reaction mixture (FIG. 5C).

The radiation source may comprise one or more of a semiconductor optical source, a light-emitting diode optical source (e.g. a white or blue LED), a compact fluorescent light source, an ultraviolet optical source, a deep-ultraviolet optical source, and the like. In some embodiments, the radiation source emits visible light (avoiding high energy and hazardous UV irradiation).

Further embodiments of the present disclosure provide a method of catalyzing a reaction comprising exposing one or more reactants to a surface of a photocatalyst comprising non-conjugatively linked chromophores coated on a substrate; and directing electromagnetic radiation either i) through said substrate and said coating of said photocatalyst to catalyze a reaction of said one or more reactants, or ii) through said volume to said coating of said photocatalyst to catalyze said reaction of said one or more reactants.

Photocatalysts that are compatible with the systems and methods disclosed herein include PIM-1 and PIM-1 analogs having non-conjugatively linked chromophores. Without being bound by theory, the modularity of a catalyst system having non-conjugatively linked chromophores provides for superior photocatalyst activity. Conjugation is closely related to the photophysical properties of a system. Connecting two conjugated systems has a significant impact on their properties. A conjugation-breaking system has more regularity because each chromophore is “insulated” from its neighbors with the polymer form of the catalyst more like the analogous small-molecule form. Thus, any conjugation-breaking linkage is compatible with the polymers disclosed herein which are useful for backside or frontside irradiation, e.g. linkages as disclosed in McKeown et al., Chemical Society Reviews, 2006, 35, 675-683.

A backside irradiation process enables efficient photoactivation of systems suffering from poor light transmittance such as large-scale batch reactions and opaque reaction mixtures. Backside or frontside irradiation can be used anywhere photoredox chemistry is conducted (e.g. pharmaceutical industry, polymer industry, etc.). Exemplary reactions include, but are not limited to, atom transfer radical addition reactions, hydrodehalogenation reactions, cycloadditions, etc. In some embodiments, a photocatalyst as described herein is used for photodegredation of environmental contaminants, e.g. for the purification of contaminated water.

The photocatalysts described herein are suitable for any redox reaction as long as the reduction/oxidation potentials continue to meet the requirements of the reaction. The modularity of the general polymeric photocatalyst system described herein allows for preparation of specific photocatalysts with redox potentials which are appropriate for specific implementations. Straightforward solution processing means that the catalyst can be easily coated onto reaction vessels and cast into sheets, particles, etc. For example, catalyst solubility may be tunable by monomer choice, feed ratio, and extent of polymerization (see Example 1). With appropriate solubility properties, organopolymer MPCs as described herein can be readily solution-processed into macroscopic structures such as thin-films.

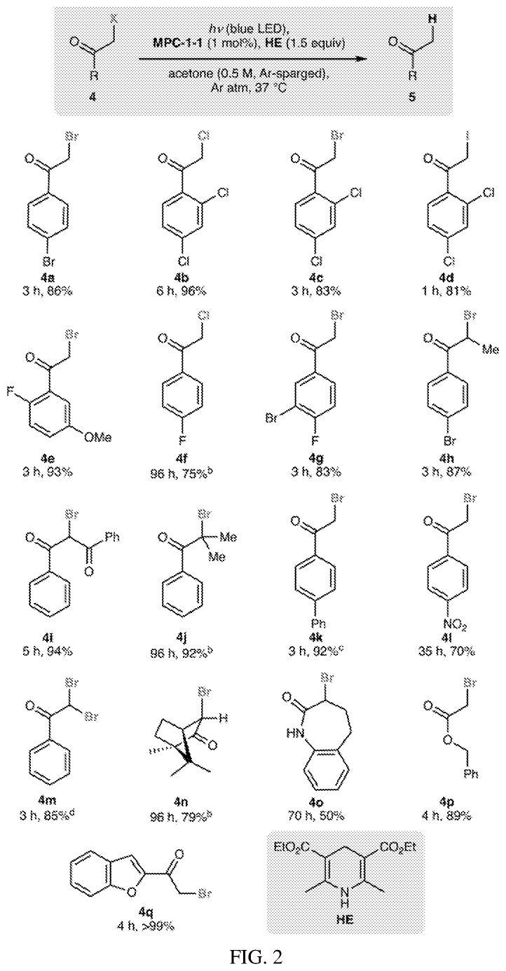

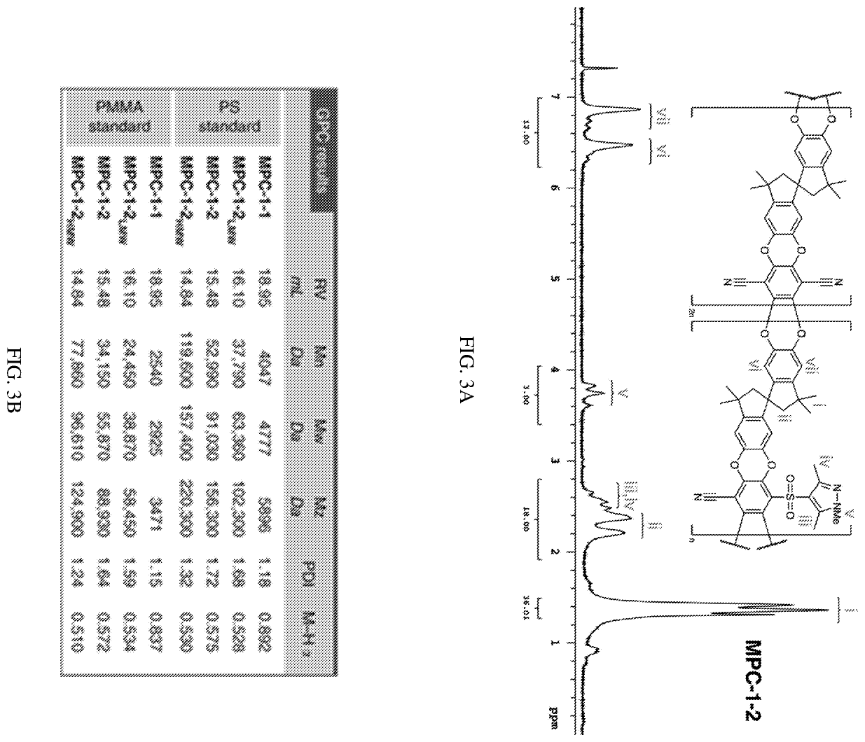

FIG. 2 provides an example photoredox reaction, hydrodehalogenation of an α-halocarbonyl compound, that may be performed using the system and catalysts described herein. In general, the photoredox reaction proceeds by contacting one or more reactants with a photoredox catalyst and a reducing agent under conditions suitable for producing the desired product. Suitable conditions may include standard procedures known by those of skill in the art. Suitable conditions may also include, e.g. reaction parameters set forth in Example 1. In some embodiments, photoredox reactions are performed in the absence of oxygen.

In some embodiments, light irradiation is applied to the reaction mixture for about 1 minute to 1 hour or more, e.g. about 2, 3, 4, 5, 6, 7, 8, 9, 10, 12, 14, 16, 18, 20, 22, 24, 26, 28, 30, 35, 40, 45, or 50 hours or more.

Further embodiments of the disclosure provide photocatalysts having the following formula:

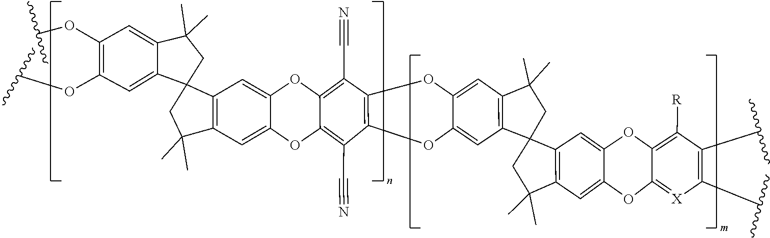

and isomers thereof, wherein X is selected from the group consisting of N, C—CN, and C—CF₃, R is a sulfone or sulfur-containing cyclic moiety, and n and m represent an integer that may be the same or different. In further embodiments, R is a phenoxazine, an N-Aryl (5,10-dihydrophenazine derivative) group, a monoaryl amine, or a diaryl amine. In some embodiments, m and/or n is zero. In some embodiments, m and/or n is at least 1. In some embodiments, n represents an integer that is at least twice the value of the integer represented by m. In some embodiments, m represents an integer that is at least twice the value of the integer represented by n. In some embodiments, n and/or in represent an integer of 1 to 1000. For example, n or m may represent an integer of 1 to 500, 1 to 250, 5 to 100, 10 to 90, 20 to 80, 30 to 70, 40 to 60, etc.

It is to be understood that the term “isomers” includes stereoisomer and polymers having a random alteration of the subunits defined by brackets in the above formula throughout the length of the polymer.

Further embodiments of the disclosure provide photocatalysts having h following formula:

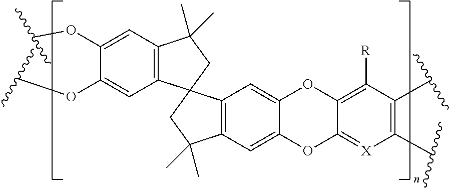

and isomers thereof, wherein X is selected from the group consisting of N, C—CN, and C—CF₃, R is a sulfone or sulfur-containing cyclic moiety, and n represents an integer of at least 1. In some embodiments, the photocatalyst does not include a terephthalonitrile-containing monomer.

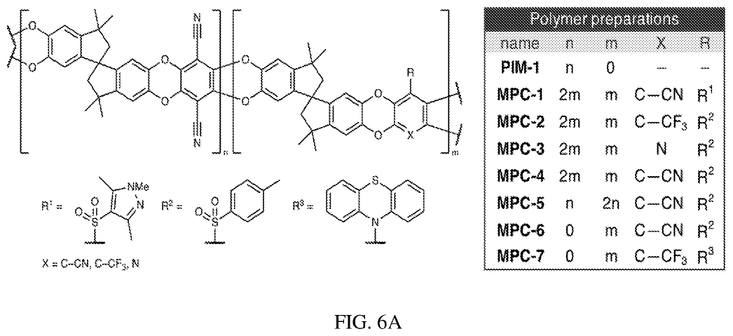

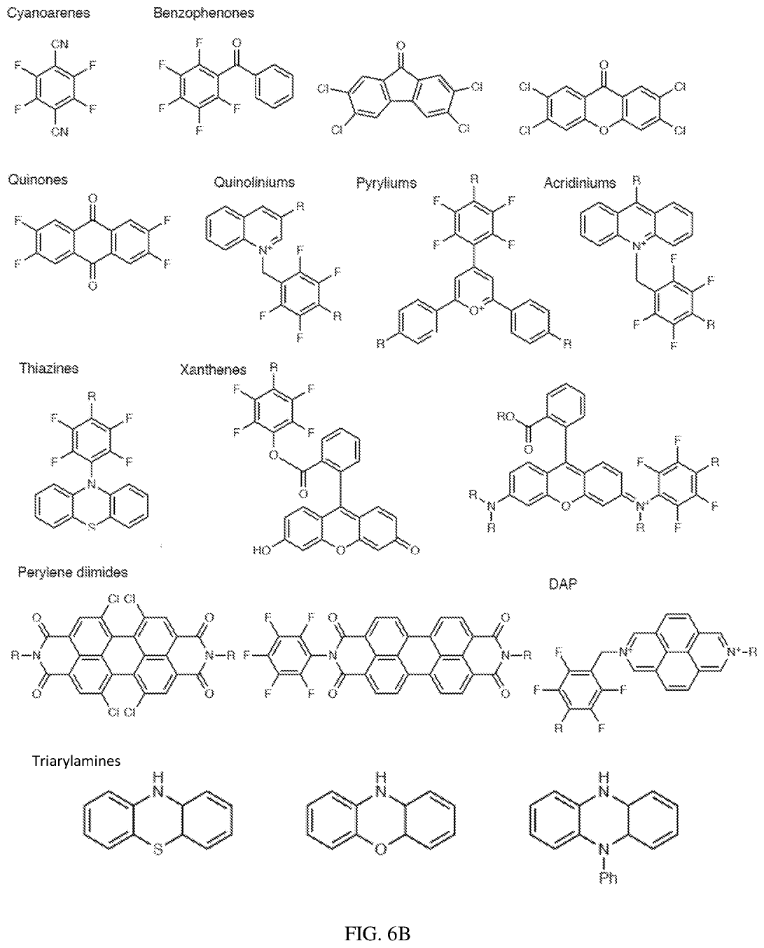

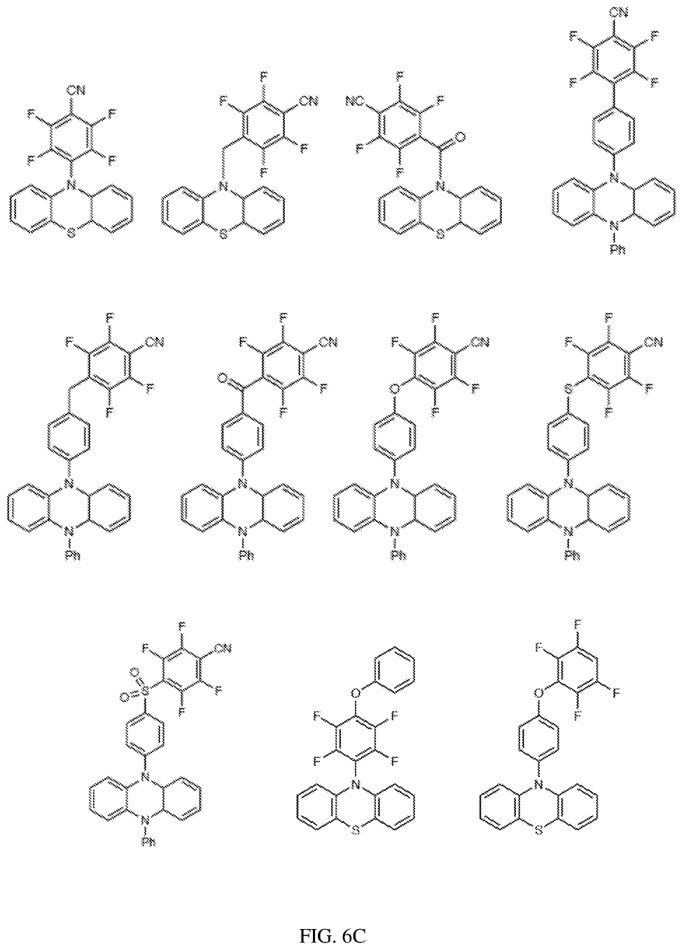

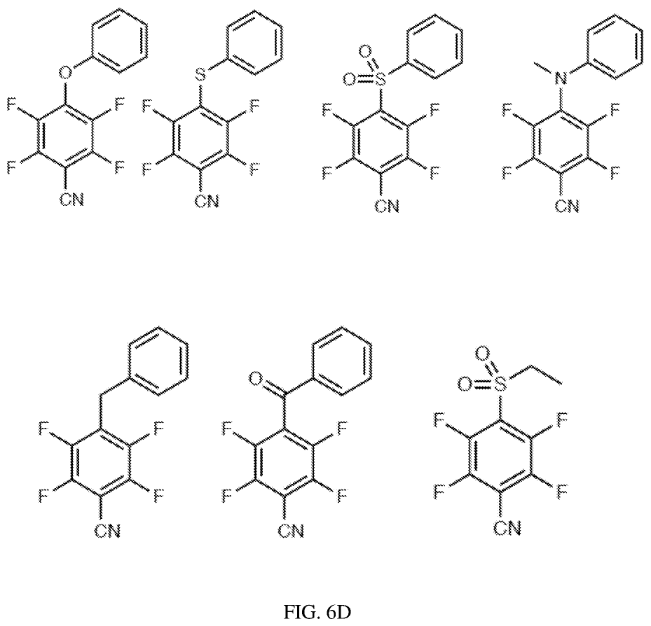

In some embodiments, the sulfone or sulfur-containing cyclic moiety is a moiety or derivative thereof as shown in FIG. 6A. For example, MPC-7 contains phenothiazine, a sulfur-containing cyclic moiety. In some embodiments, the S of the R3 group is replaced with an O (phenoxazine) or an N-Aryl (5,10-dihydrophenazine derivative) group.

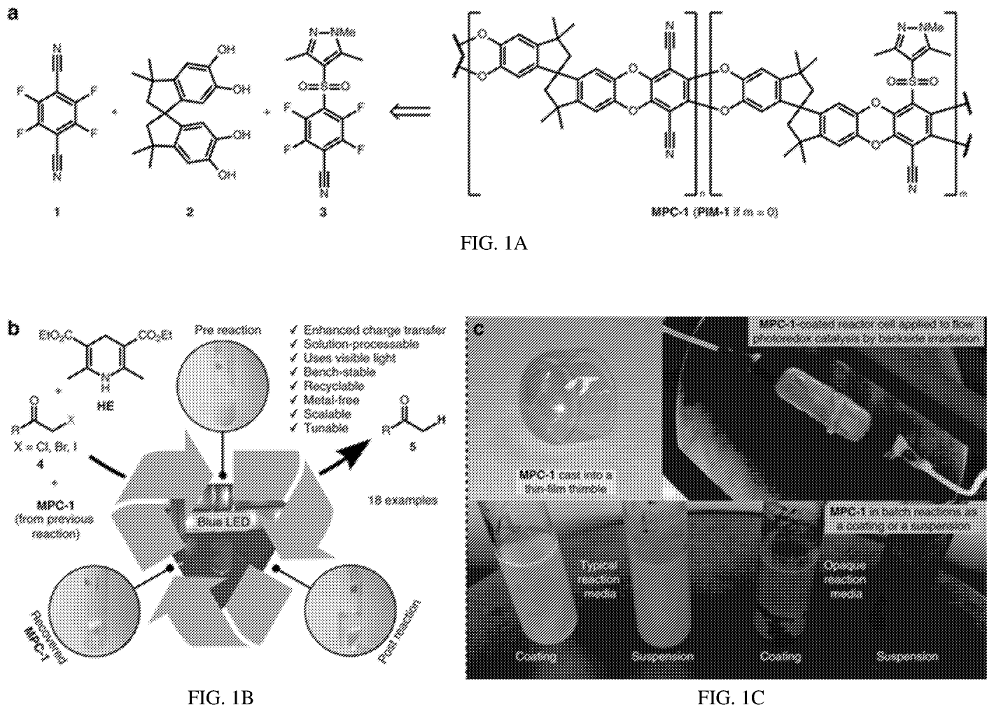

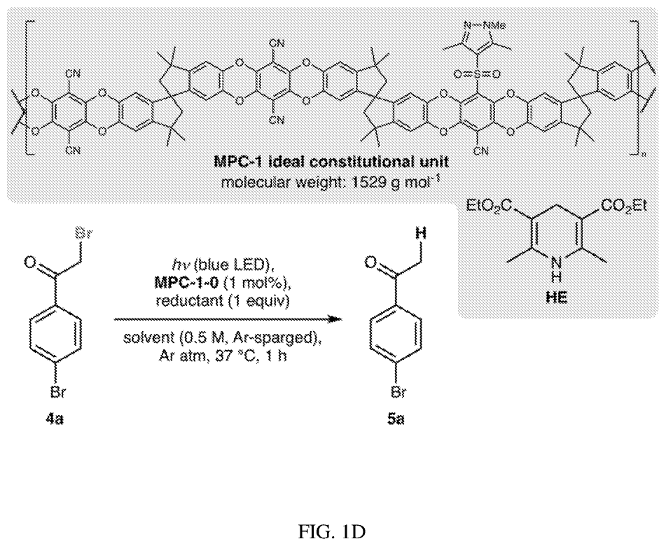

In some embodiments, the compounds described herein are multi-chromophoric, i.e. the compounds proximally incorporate at least two distinct chromophores, such as benzo[1,2-b:4,5-b′]bis[1,4]benzodioxin-6,13-dicarbonitrile and 13((1,3,5-trimethyl-1H-pyrazol-4-yl)sulfonyl)-benzo[1,2-b:4,5-b′]bis[1,4]benzodioxin-6-carbonitrile (FIG. 1A). Any chromophore monomers may be incorporated. In some embodiments, the incorporated chromophores have different redox potentials. In some embodiments, the presence of different isomers of a single chromophore may provide different redox potentials. In addition to redox potentials, chromophore monomers may be chosen to vary parameters such as absorption and emission wavelengths, excited state lifetimes, catalytic activities, etc. Additional exemplary chromophore motifs are provided in FIG. 6B-D. Derivatives of all motifs shown in FIGS. 6A-6D are also contemplated. It is further contemplated that all motifs shown in FIGS. 6A-6D may occupy the R and/or X position of the formula provided herein.

In some embodiments, the polymer is an analogue of PIM-1 . Without being bound by theory, the charge-transfer states (CTSs) of the photoredox catalyst may arise from intramolecular transfer between separate chromophores. These CTSs are associated with half-filled molecular orbitals and exhibit long lifetimes.

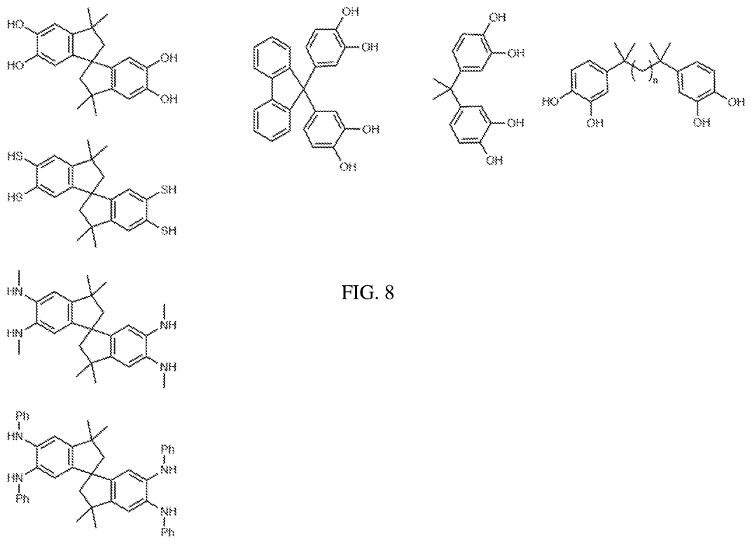

In some embodiments, the chromophore monomers are separated by a flexible, conjugation-breaking spirocyclic comonomer, e.g. a spirocyclic tetraol motif. Exemplary linkers are provided in FIG. 8. Many previous macromolecular organic photocatalysts such as poly(p-phenylene), mesoporous graphitic carbon nitride, and poly(azulene-co-benzene) are fully conjugated, meaning that delocalized z electrons can freely move between chromophores through the interchromophore linkages. In contrast, the catalysts described herein are dual-strand linear polymers containing spirocyclic linkages which break conjugation. The linkages described herein lead to intra-polymer synergy due to a fixed chromophore proximity and fixed relative orientation. That is, increasing the degree of polymerization does not simply make the catalyst heterogenous, but may make the catalyst more active. The polymer structure described herein may enhance the catalytic activities of known chromophore motifs thus improving per-chromophore catalytic efficiency.

Additional co-monomers may be added to the polymeric catalysts disclosed herein, e.g. to influence the macromolecule's solubility, adhesiveness (e.g. to a substrate such as a glass curtain or vessel wall), post-functionalizability (e.g. for cross-linking reactions etc. The additional co-monomers may or may not be chromophores.

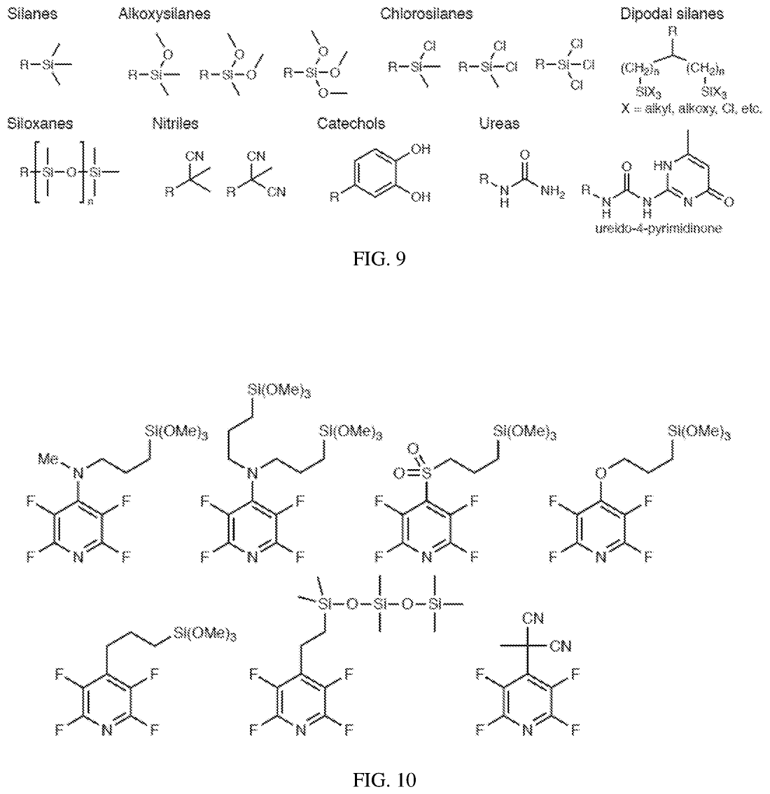

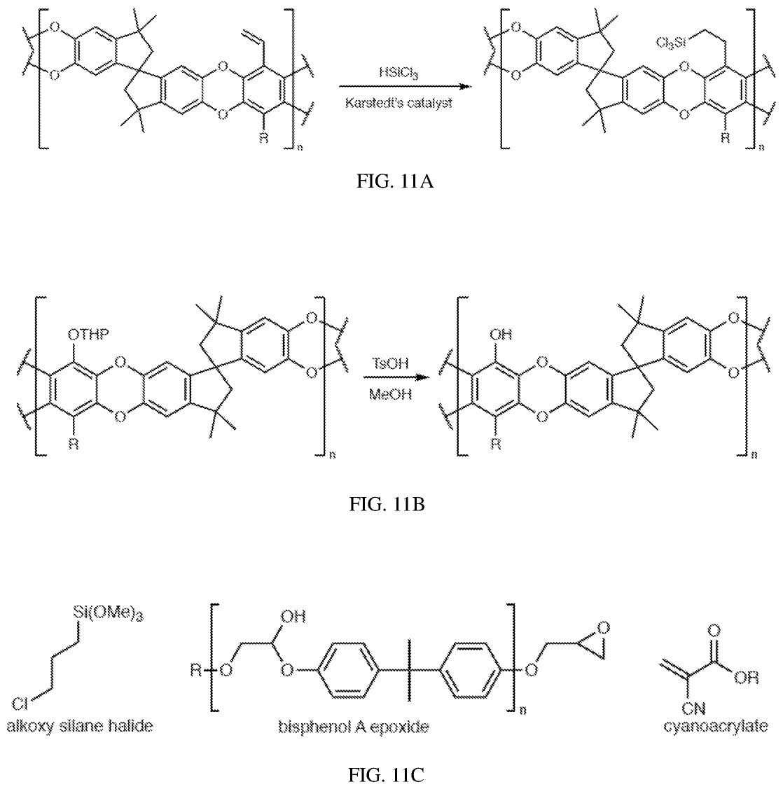

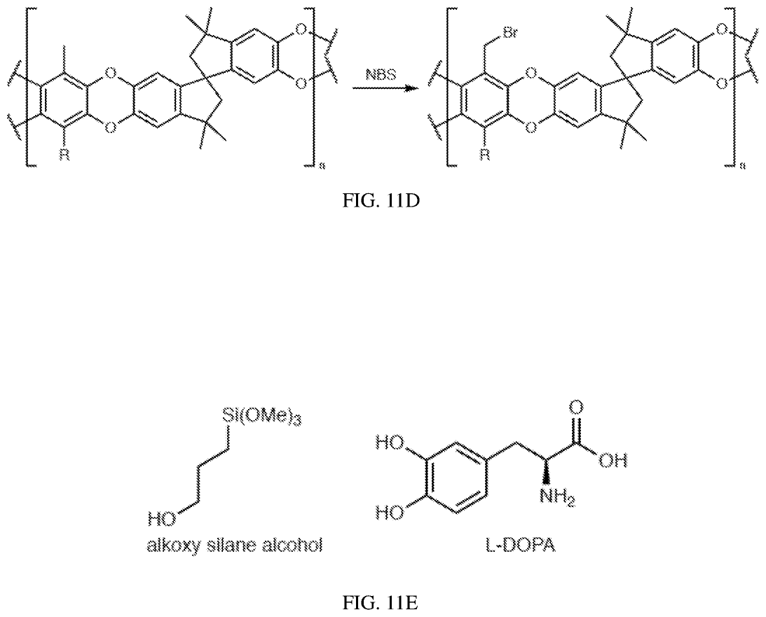

Exemplary functional groups that may improve adhesion to glass include silanes(Ankles et al., “Silane Coupling Agents: Connecting Across Boundaries, 3^{rd} Edition, 2014, gelest.com), siloxanes (such as in silicone sealant), nitriles such as in poly(cyanoacrylate)s (super glue), alkoxysilanes, chlorosilanes, dipodal silanes, catechols, urea derivatives such as ureido-4-primidinone (Heinzmann et al., Chem. Soc. Rev., 2016, 342), epoxide poly/oligomers or derivatives such as bisphenol A epoxide poly/oligomers, etc. (FIGS. 9-11). Co-monomers may be attached to the polymer catalysts described herein in the initial preparation of the polymer catalyst as a monomer, added via postfunctionalization of an incorporated monomer, or applied as a mixture with the polymer catalyst during the application of a coating. For silicon-containing monomers, the extent to which fluoride liberated during the photocatalyst polymerization causes side reactions with silicon may be assessed. If side reactions do occur, fluoride scavengers may be introduced.

The subunits of the compounds may possess intrinsic microporosity, i.e. microporosity that is derived from the molecular structures of the polymer rather than introducing the interconnecting pores by means of processing or a ‘templated’ preparation within a colloidal system. The term “microporous” is intended to encompass materials which may also be described as “nanoporous”.

In some embodiments, the compounds described herein may be used as solution-processable, heterogenized photocatalysts. Compared to prior technology, the disclosed catalysts are more sustainable (metal-free, easily recyclable), more easily handled (do not decompose in the presence of oxygen or water, are solution-processable), avoid contamination of reaction products, and are highly tunable (absorption wavelength, reduction potential, solubility, macromolecular structure).

Membranes or films comprising a compound of the disclosure may be of a form selected from the group consisting of: a pressed powder, a collection of fibers, a compressed pellet, a composite comprised of a plurality of individual membrane layers, a free standing film, and a supported film. In some embodiments, the membrane or film has a thickness which is less than or equal to 2 mm, e.g, less than or equal to 1 mm. The membrane or film may have a thickness which is in the range 1 μm to 500 μm, 10 μm to 100 μm, 50 to 500 μm, or 150 to 350 μm. Free standing or supported membranes or films may be produced by solvent casting techniques known in the art.

In addition to films, the polymers can be cast into the form of tubes, vessels, macroporous frits, plates, etc. which allows the catalyst to be applied to a wide variety of reactor designs. In some embodiments, the photocatalyst is cast into the form of a vessel or tube that will contain the reaction mixture. Methods for forming a polymer catalyst into a vessel have been demonstrated using PIM-1 in pervaporation applications.

Photocatalysts described herein may also be incorporated into a photovoltaic cell (or solar cell) that converts the energy of light into electricity. Various types of photovoltaic cells are known in the art (see e.g. US 20060249202; US 20120211741; US 20120318319; U.S. Pat. Nos. 8,153,888; 7,217,882; and 9,209,321 incorporated herein by reference).

Photocatalysts described herein may also be incorporated into composites with semiconductors and into organic electronics (e.g. photoconductors, organic light emitting diodes, etc.).

In some embodiments, the photocatalyst is provided as a solution. In some embodiments, the photocatalyst is dissolved in a solvent comprising N-methyl-2-pyrrolidone, chloroform, acetone, acetonitrile, dimethyl sulfoxide, water, aqueous sodium dodecyl sulfate (SDS), methylene chloride, tetrahydrofuran, etc. Surfactants that may be included in a solution include SDS, Triton X-100, PS-750-M, Tween 20, etc.

In some embodiments, the photocatalyst is contained within a “spray can” or other dispensing container suitable for applying the catalyst to a surface.

In some embodiments, the photocatalyst is coated on a surface of a container or flow through cell or on a substrate inserted into a container or flow-through cell (see FIGS. 12A-B), and enables either front side or back side irradiation to have the photocatalyst catalyze a reaction between two or more reactants that are positioned adjacent the coating or flow past the coating. The photocatalyst advantageously adheres to a substrate such as glass, plastic, ceramic, or metal. For backside irradiation, the substrate on which the photocatalyst is coated is transparent or at least has reduced absorption for the electromagnetic radiation (UV, Visible light, infrared, etc.) used to initiate the catalytic reaction by the photocatalyst. The photocatalyst may also be transparent.

Virtually any kind of reaction that is mediated by a photocatatalyst can be used in the practice of the invention including particularly and without limitation: (1) Atom transfer radical additions (e.g. see Wallentin et al., J. Am. Chem. Soc., 2012, 8875 disclosing a reaction between a system (alkene, alkyene, the five-membered ring of an indole, etc.) and an alkyl halide (X=Cl,Br,I)), (2) Direct C-H functionalizations (e.g. see Ghosh et al., Science, 2019, 360 disclosing a reaction between an (electron-rich) arene (pyrroles, benzene derivatives with electron donating groups like 1,3,5-trimethoxybenzene, etc.) and a radical source (alkyl halides [where X=Cl,Br,I], perfluoroiodoarenes/perflurochloroarenes/perfluorobromoarenes, sulfinate salts, etc.)), (3) Reduction of nitro groups to amines (e.g. see Gazi et al., Appl. Catal. B, 2011, 317 disclosing functional group transformation of a nitro group into an amine in the presence of a hydrogen source (e.g., sodium borohydride)), (4) Oxidation of “alkyl benzenes, amino acids, phenols, saccharides, water, and other substrates” (e.g. see Dongare et al., Proc. Nod Accu. Sci. USA, 2017, 9279 as well as the references cited therein), (5) Cis/trans isomerization of double bonds within alkenes, azo compounds, etc., (6) Carbonyl metathesis (e.g. see Wang et al., Chem. Sci., 2019, 4580 disclosing the reaction of aromatic aldehydes to form an alkene (in the presence of catalytic 4-Me-BnSH and stoichiometric. B2Pin2 and carbonate base), and (7) Carbon-sulfur bond formations (e.g. see Wimmer and König, Beilstein J. Org. Chem. 2018, 54 disclosing a thiol-ene reaction (a thiol and an alkene cobine to form a thioether)).

The polymers described herein are generally solution processable. Solution processability makes it so that the polymer can be applied to existing surfaces or cast into desirable shapes. In some embodiments, polymer-supported photocatalysts may be solution processable but then may not be as effective in solid form because the photocatalysts which are tethered to the main chain might not consistently end up on the surface of the resultant solid.

Other advantages of the polymer catalysts described herein include the intrinsic catalytic activity, meaning that the whole polymer structure is a catalyst, as opposed to a system where there is an inert backbone and catalysts are attached to it and catalysts might become entrapped inaccessibly in the interior of the polymer upon solidification. The polymer catalysts also have intrinsic porosity. Intrinsic catalytic activity and intrinsic porosity make it so that active sites are not made inaccessible to reactants. The polymer catalysts also have modularity through the non-conjugatively linked chromophores. Thus, the general design motif can be rationally adapted to the needs of particular implementation of the technology (because the chromophores are not conjugatively linked, key properties like redox potentials should not change greatly due to the nature of the neighboring chromophore monomer or the length of the polymer chain).

The present disclosure further provides methods for preparing the compounds as described herein. Compounds of the present teachings can be prepared in accordance with the procedures outlined herein (see Example 1), from commercially available starting materials, compounds known in the literature, or readily prepared intermediates, by employing standard synthetic methods and procedures known to those skilled in the art. Standard synthetic methods and procedures for the preparation of organic molecules and functional group transformations and manipulations can be readily obtained from the relevant scientific literature or from standard textbooks in the field. It will be appreciated that where typical or preferred process conditions (i.e., reaction temperatures, times, mole ratios of reactants, solvents, pressures, etc.) are given, other process conditions can also be used unless otherwise stated. Optimum reaction conditions can vary with the particular reactants or solvent used, but such conditions can be determined by one skilled in the art by routine optimization procedures. Those skilled in the art of organic and inorganic synthesis will recognize that the nature and order of the synthetic steps presented can be varied for the purpose of optimizing the formation of the compounds described herein.

The preparation methods described herein can be monitored according to any suitable method known in the art. For example, product formation can be monitored by spectroscopic means, such as nuclear magnetic resonance spectroscopy (e.g., 1H or 13C), infrared spectroscopy, spectrophotometry (e.g., UV-visible), mass spectrometry, or by Chromatography such as high pressure liquid chromatography (HPLC), gas chromatography (GC), gel-permeation chromatography (GPC), or thin layer chromatography (TLC).

Before exemplary embodiments of the present invention are described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

As used herein, the term “about”, in the context of concentrations of components, conditions, other measurement values, etc., means+/−5% of the stated value, or +/−4% of the stated value, or +/−3% of the stated value, or +/−2% of the stated value, or +/−1% of the stated value, or +/−0.5% of the stated value, or +/−0% of the stated value.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the tiling date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as in “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The invention is further described by the following non-limiting examples which further illustrate the invention, and are not intended, nor should they be interpreted to, limit the scope of the invention.

### EXAMPLE 1

Summary

Photocatalytic polymers offer an alternative to prevailing organometallics and nanomaterials, and they may benefit from polymer-mediated catalytic and material enhancements. Oligomeric and polymeric MPC-1 preparations both promote efficient hydrodehalogenation of α-halocarbonyl compounds while exhibiting different solubility properties. The polymer is readily recovered by filtration. MPC-1-coated vessels enable batch and flow photocatalysis, even with opaque reaction mixtures, via “backside irradiation.”

Materials and Methods

### General Experimental Details

All manipulations were carried out under air unless otherwise noted. Solvent molarity listed in reaction schemes is relative to the limiting reagent. The molecular weight for all MPC-1 preparations (MPC-1-0, MPC-1-1, MPC-1-2, MPC-1-2_{LMW}, and MPC-1-2_{HMW}) was approximated as 1529 g mol⁻¹, which corresponds to the constitutional unit of an ideal regular polymerization at the monomer ratio used in all preparations; the optimal polymer preparation, MPC-1-2, was in very close agreement with this approximation based on NMR and GPC measurements. NMR spectra were recorded at 23° C. on Varian MR-400, Varian Unity INOVA 500, and Varian VNMRS 700 spectrometers (400, 500, and 700 MHz, respectively). Reported chemical shifts are referenced to residual solvent peaks. GCMS data was obtained using a Thermo Scientific Trace 1300 Gas Chromatograph coupled with a Thermo Scientific ISQ-QD Single Quadrupole Mass Spectrometer, Infrared absorbance spectra were acquired on a PerkinElmer Spectrum Two spectrometer using 1 cm⁻¹ resolution unless stated otherwise. High-resolution mass analyses were obtained either using a 5975C Mass Selective Detector coupled with a 7890 A Gas Chromatograph (Agilent Technologies) or orbit-trap. Matrix-assisted laser desorption/ionization time-of-flight analyses were obtained using a Balker Autoflex III.

### Preparation of Polymer Photocatalysts

MPC-1-1: Monomers 3 (1 equiv, 0.115 mmol), 1 (2 equiv, 0.23 mmol), and 2 (3 equiv, 0.345 mmol), and potassium carbonate (10 equiv, 1.15 mmol) were stirred at reflux in 4.6 mL 3 wt % PS-750-M for 2 h. The resultant yellow solid was collected over a fritted glass funnel by vacuum filtration and rinsed with deionized water. The solid was then suspended in 15 mL deionized water, stirred at reflux for 9 h, and again collected over a fritted glass funnel by vacuum filtration. After subjecting the solid to high vacuum for 2 h, it was dissolved in DCM and passed through a Celite plug. DCM was removed under reduced pressure, the solid was triturated in pentane. After removal of pentane, the solid was placed under high vacuum for 24 h.

MPC-1-2: Prior to use, monomer 1 (99%, Sigma-Aldrich) was sublimed under vacuum at 155° C., monomer 2 (96%, Sigma-Aldrich) was recrystallized from methanol/water, and potassium carbonate (99.8%, Fisher Chemical) was dried overnight in an oven at 200° C. A thick-walled Schlenk tube equipped with a polytetrafluoroethylene (PTFE)-coated stir-bar was charged with unactivated 3 Å molecular sieves (8-12 mesh, 400 mg) and potassium carbonate (9 equiv, 2.7 mmol) and then subjected to high vacuum at greater than 200° C. in a vacuum oven for 14 h. After cooling under vacuum, the vessel was removed and quickly charged with monomers 3 (1 equiv, 030 mmol). 1 (2 equiv, 0.60 mmol), and 2 (3 equiv, 0.90 mmol). The vessel was then briefly subjected to high vacuum and then backfilled with argon. With the vessel contents protected by positive argon pressure, dry DMAc was added by syringe. The vessel was subjected to magnetic stirring at 90° C. for 70 min, resulting in a viscous translucent yellow mixture. After cooling, the mixture congealed and 4 mL deionized water was added, resulting in a suspension of large yellow flakes. The vessel was sealed and magnetically stirred at 110° C. for 10 min and then at room temperature for 5 min. The supernatant liquid was removed by syringe and the yellow solid was thrice rinsed by stirring in 2 mL portions of deionized water, which were likewise removed. The yellow solid was then dissolved in 10 mL chloroform and admixed with 10 mL deionized water. The chloroform layer was transferred to a test tube, and the aqueous layer was extracted (2×1 mL chloroform). The combined chloroform layers were washed (1×1 mL deionized water) and then admixed with 10 mL methanol, causing the majority of the polymer to precipitate. The test tube was subjected to centrifugation, the supernatant liquid was decanted away, and the centrifuge pellet was dissolved in chloroform to 2u transfer into a storage vial: Chloroform was removed under reduced pressure and the sample was placed under high vacuum at 130° C. for 16 h.

Fractionations of MPC-1-2: Twenty-eight milligrams of MPC-1-2 was dissolved in 1 mL chloroform and reprecipitated with 30 drops of methanol. The supernatant liquid was decanted. Precipitated solid was twice more reprecipitated from chloroform with methanol in the same manner. The solid thus obtained was designated as MPC-1-2_{HMW}. Solvent was removed from the combined supernatant layers under reduced pressure to give the fractionation designated as MPC-1-2_{LMW}. After the fractionations were subjected to high vacuum, they were obtained with approximately equal masses (14 mg).

### Optimization of Hydrodehalogenation

An α-halocarbonyl compound comprises a carbonyl group of formula —(CO)— having a halogen (e.g. fluorine, chlorine, bromine, iodine, astatine, or tennessine) bound to the alpha carbon. Dehalogenation refers to the cleavage of the carbon-halogen bond. Thousands of halogenated natural products have been discovered in organisms ranging from bacteria to humans²⁴, including chloramphenicol, one of the first three broad-spectrum antibiotics^{25,26}. Conversely, halogens also feature in many persistent organic contaminants, which are not readily degraded by microbial systems²⁷. Organohalides are commonly used as pesticides, biodegradables, soil fumigants, refrigerants, chemical reagents —solvents, and polymers. They have been classified as pollutants despite their wide use in various applications. Due to which, dehalogenation is a key reaction to convert toxic organohalides to less hazardous products. Control of halogenation also allows for modulation of the biological activity of chemical scaffolds, whether drug compounds or environmental contaminants^{28,29,30}, and appreciation of the role of halogen binding in drug-target binding affinity increasingly influences drug discovery, development, and lead optimization^{31,32,33,34}.

Hydrodehalogenations have also been utilized in synthetic strategies to remove halides that have served their purpose, e.g., for alkene protection³⁵, iodocyclization³⁶, or as a blocking group³⁷. Traditional hydrodehalogenation methods, however, suffer from a number of problems with respect to toxicity, selectivity, recyclability, functional group tolerance, product purification, and operational simplicity. Hydrodehalogenation methods using a catalyst as described herein provides a more robust alternative in which the catalyst can be efficiently recovered and reused.

Except where otherwise noted, optimization reactions were conducted as follows. Solid reaction components were added to a spin-vane-equipped 10×75-mm horosilicate test tube that was then fitted with a 14/20 rubber septum. The septum was wrapped with PTFE tape, and the vessel was thrice evacuated and argon-backfilled. Liquid reaction components (including 1 equiv DMSO internal standard) were then added by syringe; the solvent (which had been sparged with argon for at least 10 min) was added last. The septum punctures were covered with electrical tape and the reaction vessel was placed in the photoreactor to stir under blue LED irradiation at 37° C. Samples for ¹H NMR monitoring of reaction progress were prepared by transferring a 20 μL reaction mixture aliquot into an empty NMR tube, quickly followed by the addition of 400 μL chloroform-d₆ and capping of the tube.

### Dehalogenation Procedures

Solvents were not dried prior to use. Procedure A: The halide (1 equiv, 0.25 mmol) was added according to its phase at room temperature. Solid reaction components MPC-1-1 (1 mol %), HE (1.5 equiv, 0.375 mmol), and halide (if solid) were added to a spin-vane-equipped 10×75-mm borosilicate test tube that was then inserted into the narrow opening of a 14/20 rubber septum. The septum was wrapped with PTFE-tape, and the vessel was thrice evacuated/argon-backfilled. Halide (if liquid) and then 0.5 mL acetone (which had been sparged with argon for at least 10 min) were added by syringe. The septum punctures were covered with electrical tape, and the reaction vessel was placed in the photoreactor to stir under blue LED irradiation at 37° C. Following reaction completion (as monitored by TLC or GCMS), the solvent was removed under reduced pressure, 0.5 mL deionized water was added, and the mixture was extracted with ethyl acetate (3×0.5 mL). The combined organic layers were dried over anhydrous magnesium sulfate, filtered, and concentrated under reduced pressure. The resultant crude residue was purified by flash chromatography.

Procedure B: This method was employed for substrates that did not approach full conversion after 96 h with Procedure A. The halide (1 equiv. 0.25 mmol) was added according to its phase at room temperature. Solid reaction components- MPC-1-1 (2 mol %), the first portion of HE (1.5 equiv, 0.375 mmol), and halide (if solid) were added to a spin-vane-equipped 10×75-mm borosilicate test tube that was then inserted into the narrow opening of a 14/20 rubber septum. The septum was wrapped with PTFE tape, and the vessel was thrice evacuated/argon-backfilled. Halide (if liquid) and then 1 mL acetone (which had been sparged with argon for at least 10 min) were added by syringe. The septum punctures were covered with electrical tape, the solvent level was marked on the outside of the vessel, and the vessel was placed in the photoreactor to stir under blue LED irradiation at 37° C. Every 24 h, the reaction was monitored by TLC and GCMS, the solvent was replenished with sparged acetone to a slightly greater level than that of the initial volume, and the reaction mixture was directly sparged for several minutes. Following GCMS analysis at 72 h and prior to replenishing the solvent level, an additional 1 equiv HE was added under an argon cone, and the vessel was resealed and returned to the photoreactor. Workup and isolation were conducted as presented in Procedure A.

Procedure C: The halide (1 equiv, 0.25 mmol), MPC-1-2_{LMW} (1 mol %), and HE (3 equiv, 0.75 mmol) were added to a spin-vane-equipped 10×75-mm borosilicate test tube that was then inserted into the narrow opening of a 14/20 rubber septum. The septum was wrapped with PTFE tape, and the vessel was thrice evacuated/argon-backfilled. A 1-mL volume of DMSO (which had been sparged with argon for at least 10 min) was added by syringe. The septum punctures were covered with electrical tape, and the reaction vessel was placed in the photoreactor to stir under blue LED irradiation at 37° C. The reaction was monitored for completion by TLC. Following reaction completion, the reaction mixture was transferred to a 16×100-mm test tube, 1 mL ice-cold deionized water was added, and the mixture was extracted with ethyl acetate (3×1 mL). The combined organic layers were dried over anhydrous magnesium sulfate, filtered, and concentrated under reduced pressure. The resultant crude residue was purified by flash chromatography.

Grain-scale hydrodehalogenation: Halide 4b (1 equiv, 5.0 mmol, 1176 mg), MPC-1-1 (0.2 mol %, 15 mg), and the first portion of HE (1.1 equiv, 5.5 mmol, 1436 mg), were added to a stir-bar-equipped 25-cm³ round-bottom flask, which was then fitted with a rubber septum. The septum was wrapped with PTFE tape, and the vessel was thrice evacuated/argon-backfilled. A 10-mL volume of acetone (which had been sparged with argon for 10 min) was added by syringe. The septum punctures were covered with electrical tape, and the reaction vessel was placed in the photoreactor to stir under blue LED irradiation at 37° C. Reaction monitoring at 15 h by ¹H NMR showed ca. 60% conversion to product 5b and also indicated that the first HE portion had been exhausted. At 16 h, the second portion of HE (0.9 equiv, 4.5 mmol, 1175 mg) was added while briefly opening the vessel under an argon cone. At 24 h, the vessel was removed from the photoreactor and acetone was removed under reduced pressure. Extractions were conducted by admixing ethyl acetate to solubilize the polymeric residue and then admixing a 9-14 times larger volume of hexanes to reform the polymeric phase. Supernatant organic layers were combined, solvent was removed under reduced pressure, and the crude reaction mixture was purified by flash chromatography (ethyl acetate/hexanes), affording product 5b in 99% isolated yield (936 mg clear faintly yellow oil), as confirmed by ¹H NMR.

### Gel-Permeation Chromatography

GPC was conducted on an Omnisec GPC from Malvern equipped with four on-line detectors: a dual-angle light scattering detector, a refractive index detector, a UV detector, and a viscosity detector. Samples were fully dissolved in THF and eluted through two columns (Viscotek, LT5000L and LT 3000L) at a rate of 1 mL min⁻¹. MPC-1-0 was not fully soluble in THF and was not analyzed. Estimation of the average number of chromophores in different MPC-1 preparations is presented in FIGS. 7-10.

A simplistic estimation of the number of chromophore units in typical chains of various MPC-1 preparations was made by tabulating the molecular weights (MWs) for polymer chains of various lengths and compositions and comparing them with the MWs obtained by GPC. For each GPC MW, the nearest lesser and greater MW values of a particular chain composition are provided along with the corresponding number of chromophores (monomeric units of 1 and 3 are considered to be chromophores). The compositions involve different ratios of the different fragments, m1, m2, and m3 (originating from monomers 1, 2, and 3, respectively). The ratio of (m1+m3):m2 is 1:1 when the number of monomer units is even; in this case the chain terminates on one end with a chromophore and on the other end with an m2 fragment. When the number of monomer units is odd, it is possible for the chain to terminate with either two chromophores or two m2 fragments. Compositions with chains ending in two chromophores are described here as “disfavoring m2,” and compositions with chains ending in two m2 fragments are described as “favoring m2.”

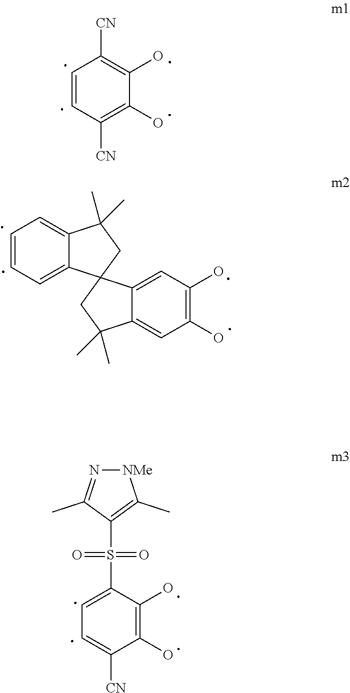

Using this approach for MPC-1-1, the number of chromophores units for a typical chain is assumed to be between 4 and 9 on the basis of the GPC Mn values estimated by the polystyrene (PS) and poly(methyl methacrylate) (PMMA) calibration standards. If it is assumed that the monomeric composition matched the feed ratio (m1:m3 of 2:1) or the ratio estimated by ¹ HNMR integrations (m1:m3 of 13:19), the typical number of chromophores is estimated to be 7-8 (PS standard) or 4-5 (PMMA standard). Based on the ratios estimated by 1H NMR, the typical chromophore counts for MPC-1-2_{LMW}, MPC-1-2, and MPC-1-2_{HMW} are estimated to be 73-74, 103-104; and 237-238, respectively (PS standard), or 47-48, 67-68 and 154-155, respectively (PMMA standard); values for other compositions are provided in FIGS. 7-10, respectively.

### Benchmarking Studies

Reaction vessels were prepared using halide 4b according to Procedure A (except with different catalysts) unless otherwise noted. The molecular weight for MPC-1 preparations was approximated as 1529 g mol⁻¹, based on the constitutional unit of an ideal regular polymerization; this constitutional unit contained three chromophores (two terephthalonitrile units and one sulfone unit). The loading for other catalysts was adjusted so as to keep the number of active units constant. Accordingly, the catalyst loading was 3 mol % with respect to active catalytic units. After stirring for 2 h under blue LED irradiation, mesitylene was added by microsyringe, and the reaction mixture was agitated to uniformly incorporate the internal standard. A 20 μL aliquot was then withdrawn by syringe and transferred to an empty NMR tube, quickly followed by the addition of 400 μL chloroform-do and capping of the tube.

### Recycle Studies

The recycle study with polymeric MPC-1-2_{LMW} was conducted using halide 4b and Procedure A (except that the catalyst and workup were changed) for the zeroth cycle. Each recycle: additional halide 4b (1 equiv, 0.25 mmol) and HE(1.5 equiv, 0.375 mmol) were added to the recovered MPC-1-2_{LMW}catalyst (1 mol %, 3.8 mg) originating from the zeroth cycle; the reaction vessel was septum/PTFE-tape-sealed, thrice evacuated/argon-backfilled, and then filled with 0.5 mL argon-sparged acetone; the punctures were sealed with electrical tape, and the reaction vessel was placed in the photoreactor to stir under blue LEI) irradiation at 37° C. For each cycle: after 3 h in the photoreactor, the vessel was removed from irradiation and its contents were diluted with 0.5 mL methanol; the resultant suspension was then passed through a fritted glass funnel, rinsing with additional methanol; the recovered solid catalyst was returned to the reaction vessel; the filtrate solvent was removed under reduced pressure, and the resultant crude residue was purified by flash chromatography (ethyl acetate/hexanes) to provide product 5b as a clear slightly yellow oil. Product purity was confirmed by ¹H NMR. The catalyst was typically returned to the reaction vessel by passing it through the frit with DCM, which was subsequently removed under reduced pressure, but after the third recycle the catalyst was returned to the reaction vessel as a solid using a spatula, and no deterioration in activity was observed.

### Flow Reactor Study

MPC-1-2_{HMW} (2.5 mol %, 26.5 mg) was dissolved in a minimal volume of DCM and transferred into a glass flow cell. Keeping the path through the cell parallel to the ground, the cell was rotated so as to coat the walls as the DCM evaporated. Small portions of DCM were added to the cell to reapply any portions of the film, which formed without adhering to the glass. Once the catalyst was evenly coated on the flow cell walls, the vessel was subjected to rotary evaporation and then high vacuum for 2 h.

Halide 4b (1 equiv, 0.700 mmol) was placed in a conical microwave vial, and HE (1.5 equiv, 1.05 mmol) was added to the MPC-1-2_{HMW}-coated flow cell. The microwave vial was fitted with a septum that had been punctured to allow two pieces of PTFE tubing to be threaded into the vessel. The other two ends of PTFE tubing pieces were connected to the flow cell, and the entire apparatus was thrice evacuated/argon-backfilled before adding 3.5 mL of argon-sparged acetonitrile to the microwave vial reservoir and placing an argon balloon needle into its septum. The reservoir was swirled until the halide completely dissolved, and then one of the pieces of PITT tubing was attached to a peristaltic pump near the photoreactor. The reactor cell was suspended in the photoreactor horizontally so as to allow the bed of HE to sit evenly across the bottom of the flow cell. Within the microwave vial, one piece of PTFE tubing was inserted all the way to the bottom of the solution while the other was kept close to the top of the vessel. The microwave vial was covered with aluminum foil to exclude the possibility of irradiation of the reservoir having any impact on the reaction. Peristaltic pumping was initiated, and the reaction was monitored by GCMS. After 26 h, the reaction was stopped, and the flow loop was drained by lifting the PTFE tubing above the reservoir liquid level. The flow loop was subsequently rinsed with 2.0 mL acetonitrile. The solvent in the reservoir was removed under reduced pressure and the product was isolated by flash chromatography in 83% yield, as confirmed by NMR.

### Cyclic Voltammetry

Cyclic voltammetry measurements were conducted with a Gamry Interface 1000 potentiostat using a glassy carbon working electrode (0.071 cm² surface area), a platinum wire counter electrode, and a silver wire pseudo-reference electrode. Prior to use, the working electrode was polished with aqueous alumina slurry, and both the working and counter electrodes were cleaned by washing sequentially with water, ethanol, acetone, and dichloromethane and then sonicating in dichloromethane for 15 min. A three-neck electrochemical cell was washed and oven-dried prior to use. Measurements were taken at a scan rate of 200 mV S⁻¹ under a nitrogen atmosphere using a 25 mL volume of 0.1 M (n-Bu)₄NPF₆ in dichloromethane. Potentials were referenced to ferrocene and adjusted to be presented relative to SCE by adding 0.38V. In the presence of the supporting electrolyte, MPC-1-2 exhibited limited solubility. Voltammograms were obtained for the solvent blank, and after each sequential addition of MPC-1-2, ferrocene, halide 4b, and Hantzsch ester to the electrochemical cell.

### Preparation of Polymer Subunit Models

All polymer subunit models were prepared as mixtures of isomers; for simplicity, only one product structure is depicted and named in each case.

### Charcoal Occlusion Study

Four 10×75-mm borosilicate test tubes were etched with a diamond Dremel bit so that etches were not more than ca. 1 mm apart and covered at least the bottom 25 mm of the tubes. Catalyst was delivered to all tubes as equal volumes of DC M-dissolved MPC-1-2_{HMW}. Two of the vessels were designated to use the catalyst as a coating, and for these vessels the DCM was removed by evaporation, then a minimal amount of DCM was added to spin coat the catalyst such that it covered the bottom 25 mm of the tubes; after spin coating, these vessels were subjected to rotary evaporation and high vacuum, and then two 0.5 mL, hexanes rinses were added and removed under reduced pressure. The other two vessels were designated to use the catalyst as a suspension, and for these vessels 0.5 mL hexanes was added to the DCM to precipitate the polymer, and then the solvent was removed by rotary evaporation; an additional 0.5 mL hexanes was added and the polymer precipitate was triturated before removing the hexanes by rotary evaporation. All four vessels were then subjected to high vacuum for 2 h.

To each vessel was added a spin-vane (pointed end up), halide 4b (1 equiv, 0.2 mmol), and Hantzsch ester (1.5 equiv, 0.3 mmol). For one vessel using the catalyst as a coating and one vessel using the catalyst as a suspension, 4 mg activated charcoal was added. Vessels were then septum-sealed, thrice evacuated/argon-backfilled, and then filled with 1 mL acetonitrile (which had been sparged with argon for 1 h). Punctures were covered with electrical tape and septa were wrapped with PTFE tape before placing the vessels in the photoreactor, and the stir plate was adjusted to stir just fast enough for the charcoal to be evenly dispersed throughout the reaction vessels. Reactions were periodically monitored by NMR analysis of 20 μL aliquots. Immediately prior to the first monitoring, mesitylene internal standard was admixed.

### Steady-State Absorption and Photoluminescence Studies

Steady-state absorption measurements were carried out on a Cary Bio 50 UV-Vis spectrometer (Agilent Technologies), in a sealed quartz cuvette with a 1-mm optical path length. Samples were dissolved in chloroform and purged with nitrogen for 30 min prior to measurement. Absorption was collected from 1.77 to 6.2 eV (200 to 700 nm). Ten separate scans of the same sample were acquired and averaged. A chloroform absorption spectrum was collected and subtracted from the spectra of all solutions. PL measurements were conducted using an LS 55 fluorescence spectrometer (PerkinElmer) with a sealed quartz cuvette with a 10-mm optical path length. Samples were dissolved in chloroform and purged with nitrogen for 30 min prior to measurement. Three excitation energies were explored: 4.2 eV (295 nm), 3.1 eV (400 nm), and 2.8 eV (445 nm). Emission was collected from 1.8 to 2.95 eV (690 to 420 nm). PL spectra were associated with singlet transitions.

Results

Investigation and Optimization of Conditions Our previous report on the synthesis of polyfluoro(hetero)aryl sulfones via micellar catalysis provided a wide variety of possible monomers for inclusion with 1 and 2 in the preparation of a PIM-1 analog⁴¹; sulfone 3 was selected and the resultant MPC system was designated as MPC-1 (FIG. 1A). We found that sulfone 3 could imbue MPC-1 with suitable photophysical and solubility properties to function as an efficient and readily recoverable catalyst for hydrodehalogenation reactions (FIG. 1B) In particular, we found that incorporation of 3 as a second chromophore subunit in the polymer supports the formation of long-lived CTSs during photoexcitation. We also found that the solution-processability of MPC-1 would allow it to be applied as a coating to flow and batch reactors (FIG. 1C). An initial preparation of the MPC-1 system (designated as MPC-1-0) was synthesized in a one-pot adaptation of a previously reported polymerization procedure¹⁷ starting from the precursors of 3; the targeted ratio of monomeric units of 1, 2, and 3 was 2:3:1. MPC-1-0 was encouragingly obtained as a bright yellow solid with a strong absorbance near 2.85 eV (435 nm), suggesting the possibility of visible-light catalysis with blue light-emitting diode (LED) irradiation. Although adequate for preliminary investigation, this preparation exhibited incomplete solubility in chloroform and under-incorporation of the sulfone monomeric unit; these deficiencies were attributed to incomplete sulfonylation and concomitant branching/cross-linking detects. For initial reactivity screening, N-methyl-2-pyrrolidone (NMP) was selected as the reaction solvent given its aptitude for solubilization of structurally similar polymers⁴². To our delight, NMP fully dissolved the polymer, and α-keto bromide 4a underwent hydrodehalogenation in the presence of i-Pr₂NEt sacrificial reductant, 1 mol % MPC-1-0 (based on the molecular weight of the constitutional unit of an ideal regular polymer), and blue LED irradiation (Table 1, entry 1). Control experiments confirm that the MPC-1 system catalyzed the transformation and that sacrificial reductant, blue LED irradiation, and oxygen-free atmosphere are all essential to efficient catalysis. Screening catalyst loading confirmed that 1 mol % MPC-1-0 was suitable for preliminary optimization. Solvent screening revealed a clear correlation between reaction efficiency and solvent polarity index⁴³ (Table 1, entries 1-6), suggesting the reaction pathway involves excited-state charge separation, which is more effectively stabilized by more polar solvents⁴⁴. NMP was the only solvent capable of fully dissolving the polymer, but the ability of the solvent to dissolve MPC-1-0 (which was used as a finely ground powder) was of limited importance, indicating that the catalyst worked well in both homogenous and heterogeneous states. Indeed, although NMP was the most effective solvent, dimethyl sulfoxide (DMSO) was nearly as competent and is a far greener choice⁴⁵. Water is the greenest solvent, has the highest polarity index, and appeared competent with 41% conversion after 1 h, but the poor solubility of 4a in water led to clumping of the substrate into a solid mass on the spin-vane, preventing the reaction from going to completion. An aqueous solution of anionic surfactant sodium dodecyl sulfate (SDS, entry 8) likewise permitted partial reaction progress, but the reaction mixture eventually developed clumping and opacity that prevented reaction completion. Isolated yields of reactions run with i-Pr₂NEt were consistently poor (ca. 40%) due to side reactions, but switching the reductant to Hantzsch ester (HE) dramatically increased reaction rate and yield (entry 9). Following optimization of HE loading, acetone was deemed sufficiently competent and was selected as a green and easily distillable reaction medium⁴⁵. With the final optimized conditions, dehalogenated product 5a was successfully obtained in 92% isolated yield after 3 h in acetone with 1.5 equiv HE and 1 mol % MPC-1-0 (entry 10).

TABLE 1
Optimization of reaction conditions.

| Entry^{a} | Reductant | Solvent | Yield (%)^{b} |
|---|---|---|---|
| 1 | i-Pr₂NEt | NMP | 47^{c} |
| 2 | i-Pr₂NEt | 2-MeTHE | 5 |
| 3 | i-Pr₂NEt | Chloroform | 14 |
| 4 | i-Pr₂NEt | Acetone | 15 |
| 5 | i-Pr₂NEt | Acetonitrile | 23 |
| 6 | i-Pr₂NEt | DMSO | 45 |
| 7 | i-Pr₂NEt | Water | 41^{d} |
| 8 | i-Pr₂NEt | 3 wt % aq. SDS | 32^{d} |
| 9 | HE | NMP | 100^{e} |
| 10 | 1.5 equiv HE | Acetone | 92^{f} |

HE Hantzsch ester, 2-MeTHF 2-methyltetrahydrofuran
^{a}Conditions: 4a (0.25 mmol), MPC-1-0 (1 mol % approximating the molecular weight as 1529 g mol⁻¹ for the ideal constitutional unit), reductant (0.25 mmol), solvent (0.5 mL, argon-sparged), argon atmosphere, 10 × 75 mm borosilicate test tube (spin-vane-equipped, septum/PTFE-tape-sealed), blue LED irradiation, 37° C., 1 h, unless otherwise noted
^{b}Determined by ¹H NMR
^{c}Average of two runs (44 and 49%)
^{d}Purely aqueous and surfactant reaction media suffered from solution turbidity and/or clumping of solids, which prevented reactions from going to completion and led to aliquots being unrepresentative of progress in the overall mixture
^{d}81% at 5 min
^{f}Isolated yield after 3 h

Reaction Scope and Sect/Ability, with Oligeonerie MPC-1-1

A new procedure was developed to produce oligomeric MPC-1, designated as MPC-1-1, while avoiding the defects associated with the one-pot procedure used for MPC-1-0. Polymerization was conducted in 3 wt % aqueous PS-750-M surfactant using separately synthesized sulfone 3; the feed ratio of monomers 1, 2, and 3 was 2:3:1. PS-750-M was designed to mimic toxic polar aprotic solvents such as DMF⁴⁶, which had been employed in the synthesis of MPC-1-0. Typically, PIM-1 analogs are synthesized under anhydrous conditions¹⁷. By intentionally using an aqueous system, it was possible to severely restrict polymer chain length through the facile termination of chain growth by hydroxide replacement of fluorine; the micelles assisted in protecting the aromatic fluorides until polymer size was sufficiently large to precipitate out of the solution. MPC-1-1 successfully obtained as an opaque yellow solid that was readily soluble in acetone. Nuclear magnetic resonance (NMR) and gel permeation chromatography (GPC) measurements suggested that the average chain length of MPC-1-1 was sufficiently long to incorporate 4-7 chromophore subunits (i.e., monomer units of 1 or 3); although successful in producing oligomeric chains, this method was still susceptible to branching defects and appeared to under-incorporate the terephthalonitrile monomeric unit. Using MPC-1-1 under the optimized reaction conditions afforded 5a in 86% isolated yield after 3 h, indicating that the activity of the oligomeric preparation was slightly interior to MPC-1-0.

It was initially suspected that the catalytic activity of MPC-1 preparations would improve with higher degrees of polymerization; because MPC-1-1 represents a non-arbitrary lower limit in this regard, it was used to establish well-defined baseline substrate scope results. Longer-chain MPC-1 preparations indeed performed better, but the origin of this improvement turned out to be more complicated. A wide-range of α-halocarbonyl compounds were amenable to hydrodehalogenation under the established conditions. As suggested by the chemoselectivity in the reaction used for optimization, aryl halides (which exhibit a larger reduction potential) were unaffected by the reaction conditions (FIG. 2, compounds 4a-h). Aside from ketones (compounds 4a-n), alkyl aryl ethers (compound 4e), aryl nitro groups (compound 4I), amides (compound 4o), and esters (compound 4p) were also well tolerated. α-Keto chlorides, bromides, and iodides were reduced with rates that increased with decreasing magnitude of substrate reduction potential (compounds 4b-d). With a sufficient quantity of reductant, geminal bromides were both reduced (compound 4m); when only 1 equiv reductant was used, a roughly equal mixture of acetophenone and 2-bromoacetophenone products was observed. Greater steric bulk around the halide did not prevent reduction, but rate was affected in accordance with the effect of the geminal alkyl substituents on the stabilization of a radical intermediate (compounds 4h-j). In addition to α-aryl keto carbonyl systems (compounds 4a-m), reduction was successful with strained aliphatic (compound 4n) and heteroaromatic (compound 4q) ketones, as well as for α-amide (compound 4o) and α-ester (compound 4p) systems. The reactions were generally clean, affording only oxidized HE and the desired product.

Scalability and catalyst recovery were demonstrated with the gram-scale hydrodehalogenation of 4b. With a lowered catalyst loading, i.e., 0.2 mol %, product 5b is was afforded in 99% isolated yield after 24 h. In addition to the lower catalyst loading, the longer reaction time is partly attributable to the change in reaction vessel and the resultant decrease in flux of irradiation. The reaction was worked up by removing acetone under reduced pressure and extracting the product with 1:14 ethyl acetate/hexanes, a solvent system in which MPC-1-1 was insoluble. To liberate product entrapped in the polymeric phase, ethyl acetate was admixed first before precipitating the polymer back out with the addition of hexanes. A preliminary recycle study using this extraction technique confirmed that the catalyst remained active in subsequent cycles, but buildup of residual Hantzsch pyridine caused the reaction rate to decrease. This limitation to recyclability was overcome with the development of a longer-chain MPC-1 preparation, MPC-1-2, which was fully recyclable and retained its catalytic efficiency over multiple recycles (vide infra).

### Synthesis and Evaluation of Polymeric MPC-1-2

Rigorous polymerization conditions were devised to yield long chains with limited cross-linking defects. Monomer 1 was purified by sublimation, monomer 2 was recrystallized from methanol/water, monomer 3 was purified by column chromatography, and potassium carbonate was dried in a vacuum oven at 200° C. overnight prior to use. The polymerization was conducted in a thick-walled Schlenk tube under argon atmosphere at 90° C. in dry N,N-dimethylacetamide (DMAc). Activated 3 Å molecular sieves were included in the reaction mixture to scavenge moisture. Upon reaction completion, the reaction mixture was extracted with chloroform and the product was precipitated out with the addition of methanol. Thus, resultant polymer preparation MPC-1-2 was obtained as a translucent yellow solid. To assess the significance of different polymer chain lengths within MPC-1-2, which had a moderate polydispersity index, a portion of the material was further processed by thrice reprecipitating from chloroform with methanol such that the polymer mass in the precipitate was approximately equal to the polymer mass in the combined supernatant layers; the higher molecular weight fractionation from the precipitate is designated as MPC-1-2_{HMW}, and the lower molecular weight fractionation from the supernatant layers is designated as MPC-1-2_{LMW}.

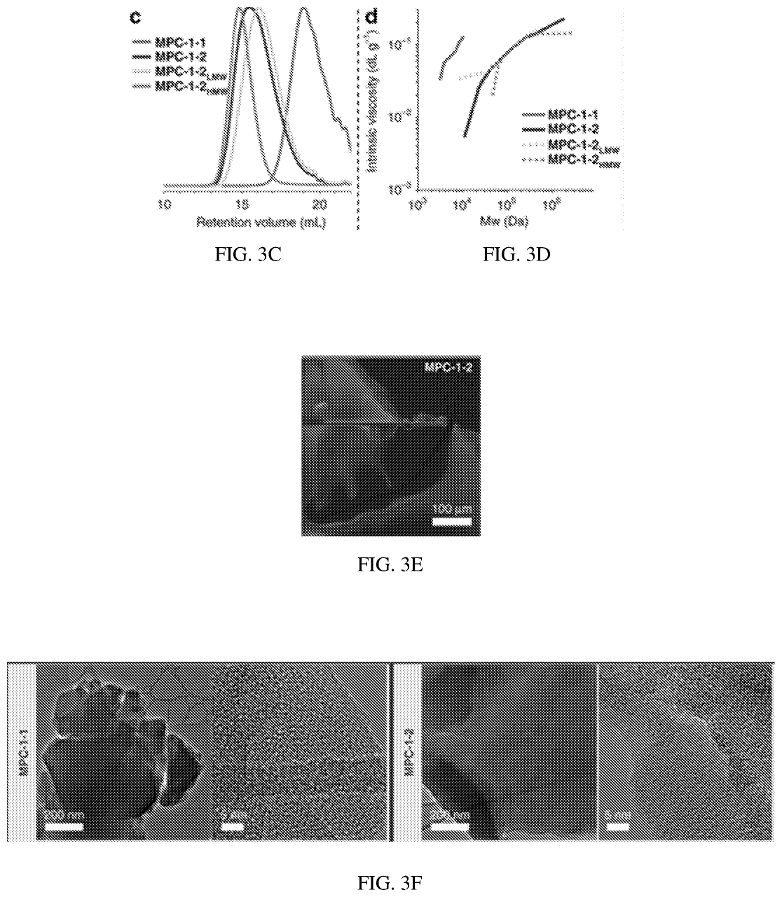

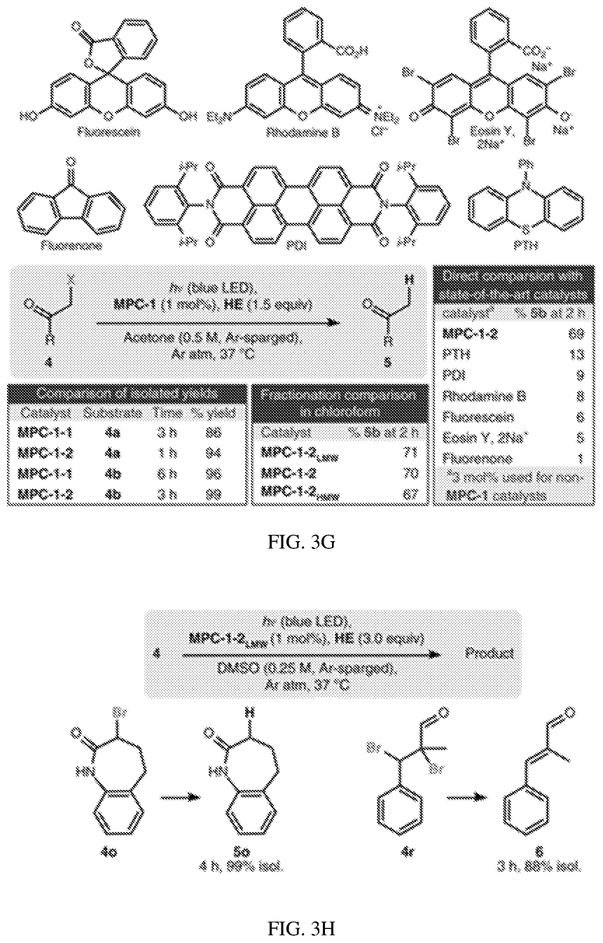

MPC-1-2 ¹H NMR integrations were in good agreement with the 2:3:1 feed ratio of 1, 2, and 3 (FIG. 3A): the alkyl methyl signals from 2 (labeled as i) integrated to 36; the methylene signals of 2 (ii) and the overlapping aryl methyl signals of 3 (iii and iv) integrated to 18; the N-methyl signals of 3 (v) integrated to 3; and the aromatic signals of 2 (labeled as vi and vii) integrated to 12. Sulfone 3 was moderately over-incorporated in fractionation MPC-1-2_{LMW} (3:1.14 ratio of 2 and 3) and under-incorporated in MPC-1-2_{HMW} (3:0.88 ratio of 2 and 3); this variation suggests either that the fractionation method is partly affected by the solubility of randomly incorporated constituent monomers, or that shorter chains tend to incorporate greater amounts of 3. Acetone admixed with MPC-1-2_{LMW} developed coloration but did not completely dissolve the solid, whereas acetone admixed with MPC-1-2_{HMW} remained colorless, suggesting that an acetone-soluble component in MPC-1-2 had been at least mostly confined to the MPC-1-2_{LMW} fractionation.

GPC results were obtained using an Omnisec GPC from Malvern, which was equipped with four on-line detectors: a dual-angle light scattering detector, an ultraviolet (UV) detector, a refractive index detector, and a viscosity detector (FIG. 3B). In the chromatogram (FIG. 3C), the refractive index peak of MPC-1--2 is situated between MPC-1-2_{LMW} and MPC-1-2_{HMW} while its distribution covered the range of both components, which was consistent with the tabulated results. Minor peaks indicating the existence of oligomers were observed at retention volume >19 mL for MPC-1-2 and its fractionations. All four samples were fully soluble in the tetrahydrofuran eluent, and Mark-Houwink plots were also constructed to assess their structures (FIG. 3D). The curves of MPC-1-2 and its fractionations overlapped with each other at a wide-range, which implied a similar Mark-Houwink exponent (M-H a) and the same branching degree with the different polymer compositions.

Fourier-transform infrared spectroscopy showed that all monomers were incorporated into the derivative polymers, and MPC-1-2 lacked the hydroxyl stretches present in MPC-1-1. Both MPC-1-1 and MPC-1-2 exhibited high thermal stability when subjected to thermogravimetric analysis (TGA) and differential scanning calorimetry (DSC), which showed very little change up to 200° C., followed by a gradual loss of mass until 450° C. A sheet of MPC-1-2 was subjected to scanning electron microscopy (SEM); the sheet was observed to be regular and smooth (FIG. 3E). High-resolution transmission electron microscopy (HRTEM) imaging of MPC-1-1 and MPC-1-2 showed that MPC-1-2 had a more regular macrostructure consisting of large layers of stacked sheets while MPC-1-1 had smaller planes of sheets with smaller and rounder edges (FIG. 3F). At high magnification, both samples were seen to exhibit a similar porous structure. Inductively coupled plasma mass spectrometry (ICP-MS) confirmed the absence of iridium and ruthenium traces, which otherwise might be responsible for observed photocatalytic activity.

Having made and characterized a variety of MPC-1 preparations, we sought to assess their catalytic activities and generalize: the results by benchmarking against well-known organophotoredox catalysts (FIG. 3G). Higher isolated yields for hydrodehalogenation of bromide 4a and chloride 4b were obtained in less time with MPC-1-2 compared to MPC-1-1. Unsurprisingly, MPC-1-2 exhibited improved catalytic activity in acetone when used as a fine powder instead of larger pieces, which would be expected to remain undissolved and thereby exclude interior active units from participating in catalysis. Accordingly, to better exclude influence of active unit entrapment in the interior of undissolved solid, the catalytic activities of MPC-1-2 and its fractionations were compared with the hydrodehalogenation of 4b in chloroform, a reaction medium in which all were fully soluble; observed activities were nearly the same. MPC-1-2 was benchmarked against six common organophotoredox catalysts' using the same model reaction in acetone. MPC-1--2 proved to be the best by far, catalyzing more than five times as much product formation as its nearest competitor in the timeframe of the experiment. Leveraging the improved catalytic activity of MPC-1-2, difficult substrate 4o was hydrodehalogenated with significant improvements to reaction rate and yield, and a vicinal dibromide was efficiently converted into the corresponding alkene (FIG. 3h).

### Recyciability of MPG-1-2

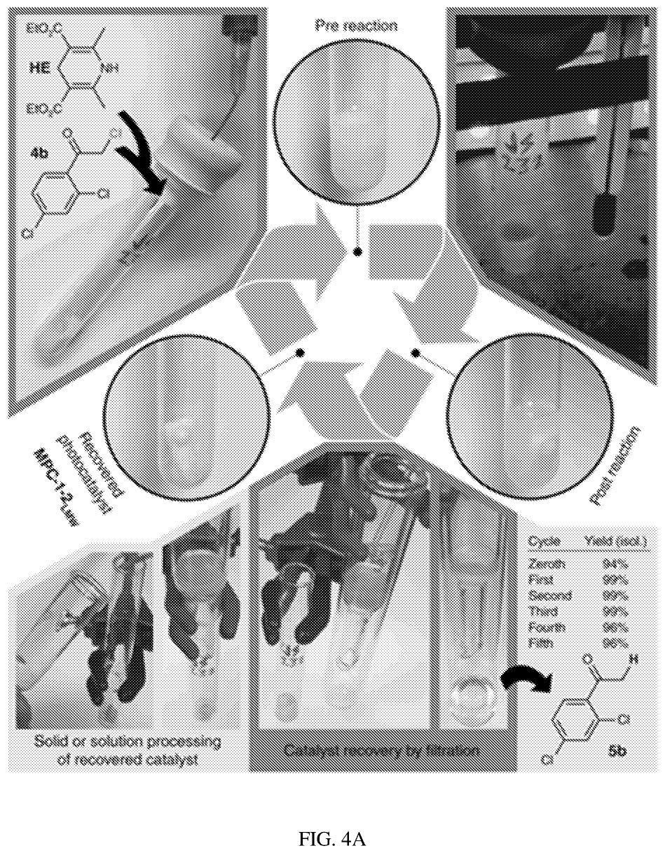

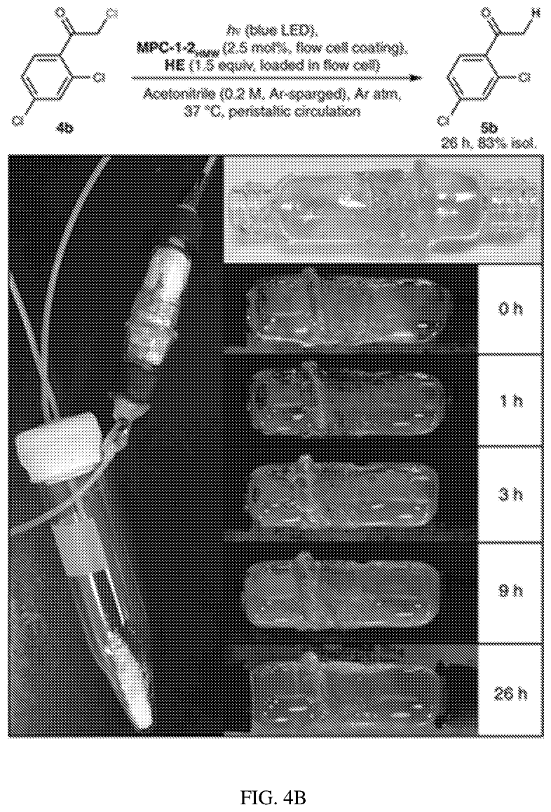

The altered solubility properties of MPC-1-2 appeared promising for improved recycling techniques. A hatch reaction recycle study was conducted using 2_{LMW} for the hydrodehalogenation of 4b under standard conditions (FIG. 4A). The partial solubility of MPC-1-2_{LMW} in the reaction medium was readily overcome upon reaction completion with the addition of methanol, whereupon the suspension was passed through a fritted glass funnel to separate the catalyst from the rest of the reaction mixture. The catalyst could then be returned to the reaction vessel as a solid or through solution processing to pass it through the frit, these two approaches worked equally well. Six reaction cycles were conducted in this manner without appreciable decrease in catalyst activity. The complete acetone solubility and limited methanol solubility of MPC-1-1 made this approach infeasible for the oligomeric system.

To further demonstrate the unique possibilities afforded by an innately photocatalytic solution-processable polymer, a new approach to catalyst recycling under flow conditions was envisioned wherein the photocatalytic polymer would be coated on the walls of a flow cell. The reaction solvent would be selected so as not to dissolve the coating. Following a post-reaction rinse, the flow cell could then be reused in subsequent reactions. Although a precedent exists for flow cells containing heterogenized photoredox catalyst immobilized by polymer support or sol-gel techniques⁴⁷, the wall-coating of a transparent and inherently photocatalytic polymer on the walls of a flow cell has not been reported. We fashioned a prototype large-volume flow cell to accommodate the poorly soluble reductant and coated its walls by dissolving MPC-1-2_{HMW} in dichloromethane, which was allowed to evaporate as the cell was rotated. The flow cell was loaded with HE and an acetonitrile solution of 4b was peristaltically circulated from a reservoir through the cell, which was subjected to blue LED irradiation (FIG. 4B). The polymer coating was retained on the walls of the flow cell throughout the course of the reaction, and after 26 h the reactor loop was drained into the reservoir and the product was isolated in 83% yield, confirming the viability of the concept. It is noteworthy that MPC-1-2_{HMW} was required for retention of the coating; unfractionated MPC-1-2 was gradually stripped from the walls under reaction conditions.

### Mechanistic Studies and Assessment of Backside Irradiation

A series of control studies were conducted with halide 4b, which confirmed that hydrodehalogenation product 5b only formed in the simultaneous presence of MPC-1, HE, and blue LED irradiation; no conversion was observed when one or more of these components was omitted. Subsequently, the ground-state redox potentials of the control reaction components were determined experimentally by cyclic voltammetry, and the excited-state redox potentials of the catalyst were estimated using the polymer emission in wavelength. On the basis of this information, a plausible mechanism is proposed (FIG. 5A). The need for the sacrificial reductant indicates that, as is often the case with the monomeric analog p-dicyanobenzene, MPC-1 is operating as an excited-state oxidant², and the reactivity-determining potential is that of the reduced form, MPC-1^{⋅-} (Eₒₓ=−1.42 V vs. SCE). Thus, following photoexcitation, MPC-1* (E_{red}=1.01 V VS. SCE) is reductively quenched through single electron transfer (SET) from reductant HE (Eₒₓ=0.89 V vs. SCE). Subsequently, SET from MPC-1^{⋅-} to halide 4h (E_{red}=−1.24 V vs. SCE) leads to homolytic cleavage of the carbon-halogen bond. The resultant alkyl radical is then converted to the product by forming a bond with a methylene hydrogen from HE^{⋅+} as it establishes aromaticity to form Hantzsch pyridine.

Well-defined models of MPC-1 substructures 7-11 were synthesized to better elucidate the effects of chain formation and dual chromophores (FIG. 5B). The activity of the models was assessed with the same reaction conditions used for the benchmarking studies (FIG. 3G); the catalyst loading was adjusted to maintain a constant amount of active chromophore units across experiments. Catalyst model 7, which contained one sulfone chromophore, was inferior to all other models with only 27% yield after 2 h. The other single chromophore model, 8, which contained the terephthalonitrile motif, was highly active, providing 99% product in the same timeframe. As the chain length was increased with models 9 and 10, the yield decreased (97% and 84%, respectively); this observation was in agreement with the expectation that yield would decrease with decreasing molecular concentration of catalyst even though active unit loading was held constant. However, when using catalyst model 11, which replaced the middle terephthalonitrile unit in 10 with the less active sulfone chromophore, the activity was superior to even single terephthalonitrile model 8; this improved activity in spite of lower molecular catalyst concentration and partial use of the less effective sulfone chromophore is in agreement with the charge-transfer state hypothesis. An additional experiment using a 1:2 ratio of models 7 and S afforded only 93% yield, indicating that the dual-chromophore activity enhancements are only present when the two-chromophore types are incorporated into the same molecule.

To further demonstrate the impact of this catalyst, backside irradiation technology was explored as a proof-of-concept (FIG. 5C). This technology could prove useful for reaction mixtures with low light transmittance. Four reactions were set-up in parallel; two vessels contained a wall-coating of MPC-1-2_{HMW}, and two contained the catalyst as a suspension; in one of each of the vessel sets, the reaction mixture was made opaque with the inclusion of charcoal (FIG. 1C, FIG. 5D). The hydrodehalogenation of 4b was more efficient with a wall-coating than with a suspension, even with the inclusion of charcoal, supporting that the backside irradiation process played a role (FIG. 5C). Likewise, coated vessels are not affected by the occlusion of light caused by undissolved HE: the trend in conversion over time for coated reaction vessels lacks the inflection point observed for vessels with catalyst suspension; this inflection point is attributable to opaque, poorly soluble HE being sufficiently converted to Hantzsch pyridine to allow for improved light transmittance.

Discussion

A photocatalytically active double-strand polymer system, MPC-1, was developed and successfully employed in the hydrodehalogenation of α-halocarbonyl compounds in mostly excellent yields. Variation of the polymerization technique demonstrated the robustness of the substituent chromophores and led to the development of MPC-1-2, a preparation with improved catalytic activity and solubility properties. The recyclability of the photocatalyst was demonstrated in batch reactions, and a proof-of-concept flow cell reactor demonstrated the efficacy of the polymer when used as a transparent wall-coating. The backside irradiation approach employed in the flow reaction was also investigated in batch mode and was found to be superior to use of the catalyst as a suspension and was effective even when the reaction mixture was made opaque with the addition of charcoal.

EXAMPLE 2

Additional examples of photoredox catalysts according to the present disclosure are provided in FIG. 6.

### REFERENCES

1. (a) Kisch, H., Angew. Chem. Int. Ed. 2013, 52 (3), 812; (b) Romero, N. A.; Nicewicz, D. A., Chem. Rev. 2016, 116 (17), 10075.
2. (a) Gazi, S.; Ananthakrishnan, R., Appl. Catal., B 2011, 105 (3), 317; (b) Dongare, P.; MacKenzie, I.; Wang, D.; Nicewicz, D. A.; Meyer, T. J., Proc. Natl. Acad. Set. U.S. A. 2017, 114(35), 9279; (c) Schmaderer, H.; Hilgers, P.; Lechner, R.; König, B., Adv. Synth. Catal. 2009, 351 (1-2), 163.
3. Bachl, J.; Hohenleutner, A.; Dhar, B. B.; Cativiela, C.; Maitra, U.; Konig, B.; Diaz, D. D., J. Mater. Chem. A 2013, (14), 4577.
4. (a) Zhang, T.; Liang, W.; Huang, Y.; Li, X.; Liu, Y.; Yang, B.; He, C.; Zhou, X.; Zhang, J., Chem. Commun. 2017, 53 (93), 12536; (b) Kurfiřt, M.; Špačková, J.; Svobodová, E.; Cibulka, R., Monatsh. Chem. 2018, 149 (4), 863; (c) Ribeiro, S. M.; Serra, A. C.; Rocha Gonsalves, A. M. d. A., J. Mol. Canal. A: Chem. 2010, 326 (1), 121.
5. Heeger, A. J., Angew. Chem. Int. Ed. 2001, 40 (14), 2591.
6. (a) Zhang, M.; Rouch, W. D.; McCulla, R. D., Eur. J. Org. Chem. 2012, 2012 (31), 6187; (b) Ghosh, I.; Khatnrai, J.; Savateev, A.; Shlapakov, N.; Antonietti, M.; König, B., Science 2019, 365 (6451), 360.
7. Lee, L. S.; Chang, C.-J., Polymers 2019,11 (2).
8. Arakawa, Y.; Kawachi, R.; Tezuka, Y.; Minagawa, K.; Imada, Y., J. Polym. Sci., Part A: Polym. Chem. 2017, 0.55 (10), 1706.
9. Zhao, Z.; Sun; Y.; Dong, F., Nanoscale 2015, 7 (1), 15.
10. Iida; Mizoguchi, T., Oh, S.-D. & Yashima; E. Redox-triggered switching of helical chirality of poly(phenylacetylene)s bearing riboflavin pendants. Polym. Chem. 1, 841-848 (2010).
11. Heeger, A. J. Semiconducting and metallic polymers: the fourth generation of polymeric materials (Nobel lecture). Angew. Chem. Int. Ed. 40, 2591-2611 (2001).
12. Ghasimi, S., Bretschneider, S. A., Huang, W., Landfester, K. & Zhang, K. A. I. A conjugated microporous polymer for palladium-free, visible light-promoted photocatalytic Stille-type coupling reactions. Adv. Sci. 4, 1700101-1700 (2017).
13. Zhao, Z., Sun, Y. & Dong, F. Graphitic carbon nitride based nanocomposites: a review. Nanoscale 7, 15-37 (2015).
14. Budd, P. M. et al. Solution-processed, organophilic membrane derived from a polymer of intrinsic microporosity. Adv. Mater. 16, 456-459 (2004).
15. Pandey, G., Hajra, S., Ghorai, M. K. & Kumar, K. R. Designing photosystems for harvesting photons into electrons by sequential electron-transfer processes: reversing the reactivity profiles of α,β-unsaturated ketones as carbon radical precursor by one electron reductive β-activation. J. Am. Chem. Soc. 119, 8777-8787 (1997).
16. Ohkubo, K., Suga, K., Morikawa, K. & Fukuzurni, S. Selective oxygenation of ring-substituted toluenes with electron-donating and -withdrawing substituents by molecular oxygen via photoinduced electron transfer. J. Am. Chem. Soc. 125, 12850-12859 (2003).
17. Du, N. et al. Polymers of intrinsic microporosity containing trifluoromethyl and phenylsulfone groups as materials for membrane gas separation. Macromolecules 41, 9656-9662 (2008).
18. Bezzu, C. G. et al. A spirobifluorene-based polymer of intrinsic microporosity with improved performance for gas separation. Adv. Mater. 24, 5930-5933 (2012).
19. Prier, C. K., Rankic, D. A. & MacMillan, D. W. C. Visible light photoredox catalysis with transition metal complexes: applications in organic synthesis. Chem. Rev. 113, 532 5363 (2013).
20. Tucker, J. W. & Stephenson, C. R. J. Shining light on photoredox catalysis: theory and synthetic applications. J. Org. Chem. 77, 1617-1622 (2012).
21. Damrauer, N. H. et al. Femtosecond dynamics of excited-state evolution in [Ru(bpy)3]2+. Science 275, 54 (1997).
22. Chergui, M. On the interplay between charge, spin and structural dynamics in transition metal complexes. Dalton. Trans. 41, 13022-13029 (2012).
23. Chergui, M. Ultrafast photophysics of transition metal complexes. ACC Chem. Res. 48, 801-808 (2015).
24. Gribble, G. W. The diversity of naturally produced organohalogens. Chemosphere 52, 289-297 (2003).
25. Ehrlich, J., Bartz, Q. R., Smith, R. M., Joslyn, D. A, & Burkholder, P. R. Chloromycetin, a new antibiotic from a soil actinomycete. Science 106, 417-417 (1947).
26. Wright, P. M., Seigle, I. B. & Myers, A. G. The evolving role of chemical synthesis in antibacterial drug discovery. Angew. Chem. Int. Ed. 53, 8840-8869 (2014).
27. Hardman, D. J. Biotransformation of halogenated compounds. Crit. Rev. Biotechnol. 11, 1-40 (1991).
28. Pathak, T. P. & Miller, S. J. Site-selective bromination of vancomycin. J. Am, Chem. Soc. 134, 6120-6123 (2012).
29. Renner, M. K., Jensen, P. R. & Fenical, W. Neomangicols: structures and absolute stereochemistries of unprecedented halogenated sesterterpenes from a marine fungus of the genus: Fusarium. J. Org. Chem. 63, 8346-8354 (1998).
30. Sturini, M. et al. Photodegradation of fluoroquinolones in surface water and antimicrobial activity of the photoproducts. Water Res. 46, 5575-5582 (2012).
31. Xu, Z. et al. Halogen bond: its role beyond drug-target binding affinity for drug discovery and development. J. Chem. Inf. Model. 54, 69-78 (2014).
32. Xu, Z. et al. Utilization of halogen bond in lead optimization: a case study of rational design of potent phosphodiesterase type 5 (PDE5) inhibitors. J. Med. Chem. 54, 5607-5611 (2011),
33. Hardegger, L. A. et al. Systematic investigation of halogen bonding in protein-ligand interactions. Angew. Chem. Int. Ed. 50, 314-318 (2011).
34. Matter. H. et al. Evidence for C Cl/C Br . . . π interactions as an important contribution to protein-ligand binding affinity. Angew. Chem. Int. Ed. 48, 2911-2916 (2009).
35. Fieser, L. F. Cholesterol and companions. VII. Steroid dibromides, J. Am, Chem. Soc. 75, 5421-5422 (1953).
36. Song, H., Liu, Y. & Wang, Q. Cascade electrophilic iodocyclization: efficient preparation of 4-iodomethyl substituted tetrahydro-β-carbolines and formal synthesis of oxopropaline G. Org. Lett, 15, 3274-3277 (2013).
37. Birman, V. B., Rheingold, L. & Lam, A. K. -C. 1,1′-Spirobiindane-7,7′-diol: a novel, C2-symmetric chiral ligand. Tetrahedron.: Asymmetry 10, 125-131 (1999).
38. Halbach, M. C., Stoltz, B. M. & Grubbs, R. H. Catalytic reduction of alkyl and aryl bromides using propan-2-ol. Angew. Chem. Int. Ed. 56, 15123-15126 (2017).
39. Nguyen, J. D. D'Amato, E. M. Narayanam, J. M. R. & Stephenson, C. R. J. Engaging unactivated alkyl, alkenyl and aryl iodides in visible-light-mediated free radical reactions. Nat. Chem. 4, 854 (2012).
40. Discekici, E. H. et al. A highly reducing metal-free photoredox catalyst: design and application in radical dehalogenations. Chem. Commun. 51, 11705-11708 (2015).
41. Smith, J. D. et al. Micelle-enabled clean and selective sulfonylation of polyfluoroarenes in water under mild conditions. Green Chem. 20, 1784-1790 (2018).
42. Balashova, I. M., Danner, R. P., Puri, P. S. & Duda, J. L. Solubility and diffusivity of solvents and nonsolvents in polysulfone and polyetherimide. Ind. Eng. Chem, Res. 40, 3058-3064 (2001).
43. Snyder, L. R. Classification of the solvent properties of common liquids. J. Chromatogr. Sci. 16, 223-234 (1978).
44. Freed, B. K., Biesecker, J. & Middleton, W. J. Spectral polarity index: a new method for determining the relative polarity of solvents [1]. J. Fluor. Chem. 48, 63-75 (1990).
45. Prat, D. et al. CHEM21 selection guide of classical- and less classical-solvents. Green Chem. 18, 288-296 (2016).
46. Brals, J., Smith, J. D., Ibrahim, F., Gallou. F. & Handa, S. Micelle-enabled palladium catalysis for convenient sp2-sp3 coupling of nitroalkanes with aryl bromides in water under mild conditions, ACS Catal. 7, 7245-7250 (2017).
47. Ciriminna, R., Delisi, R., Xu, Y. -J. & Pagliaro, M. Toward the waste-free synthesis of fine chemicals with visible light. Org. Process Res. Dev. 20, 403-408 (2016).
48. Frenkel, J. On the transformation of light into heat in solids. I. Phys. Rev, 37, 17-44 (1931).
49. Davydov, A. S. The theory of molecular excitons. Phys. -Usp. 7, 145 (1964).
50. Morrison, A. F., You, Z. -Q. & Herbert, J. M. Ab initio implementation of the Frenkel-Davydov exciton model: a naturally parallelizable approach to computing collective excitations in crystals and aggregates. J. Chem. Theory Comput. 10, 5366-5376 (2014).
51. Heid, C. G., Ottiger, P., Leist, R. & Leutwvler, S. The S1/S2 exciton interaction in 2-pyridone6-methyl-2-pyridone: Davydov splitting, vibronic coupling, and vibronic quenching. J. Chem. Phys. 135, 154311 (2011).
52. Zeng, T., Hoffmann. R. & Ananth, N. The low-lying electronic states of pentacene and their roles in singlet fission. J. Am. Chem. Soc. 136, 5755-5764 (2014).
53. Frisch M. J., et al. Gaussian 16 Revision A,03. (Gaussian, Inc., Wallingford Conn., 2016),
54. Chen, S. et al. Effect of the porosity of a Polymer of Intrinsic Microporosity (PIM) on its intrinsic fluorescence. J. Phys. Chem. B 117, 5249-5260 (2013).
55. Armarego, W. L. F. & Chai, C. Purification of Laboratory Chemicals. (Butterworth-Heinemann, Waltham, 2012).
56. Gudipudi, G., Sagurthi, S. R., Perugu, S., Achaiah, G. & David Krupadanam, G. L. Rational design and synthesis of novel 2-(substituted-2H-chromen-3-yl)-5-aryl-1H-imidazole derivatives as an anti-angiogenesis and anti-cancer agent, RSC Adv. 4, 56489-56501 (2014).
57. Okamoto, T., Kakinami, T., Nishimura, I., Hermawan, I. & Kajigaeshi, S. Preparation of aromatic iodoacetyl derivatives by direct iodination with a potassium iodide-potassium iodate-sulfuric acid system. Bull. Chem. Soc. Jpn. 65, 1731-1733 (1992).
58. Finck, L., Brals, J., Pavuluri, B., Gallou, F. & Handa, S. Micelle-enabled photoassisted selective oxyhalogenation of alkynes in water under mild conditions. J. Org. Chem. 83, 7366-7372 (2018).
59. Stodulski, M., Goetzinger, A., Kohlhepp, S. V. & Guider, T. Halocarbocyclization versus dihalogenation: substituent directed iodine(III) catalyzed halogenations. Chem. Commun. 50, 3435-3438 (2014).
60. Telfah, H., Jamhawi, A., Teunis, M. B., Sardar, R. & Liu, J. Ultrafast exciton dynamics in shape-controlled methylammonium lead bromide perovskite nanostructures: Effect of quantum confinement on charge carrier recombination. J. Phys. Chem. C. 121, 28556-28565 (2017).
61. Xie, Y., Teunis, M. B., Pandit, B., Sardar, R. & Liu, J. Molecule-like CdSe nanoclusters passivated with strongly interacting ligands: energy level alignment and photoinduced ultrafast charge transfer processes. J. Phys. Chem. C. 119, 2813-2821 (2015).
62. Pandit, B. et al. Spectroscopic investigation of photoinduced charge-transfer processes in FTO/TiO2/N719 photoanodes with and without covalent attachment through silane-based linkers. J. Phys. Chem. A 117, 13513-13523 (2013).

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

We claim:

1. A reaction system, comprising:
a photocatalyst coating comprising non-conjugatively linked chromophores having a first surface adhered to a substrate, and second surface facing a volume, wherein the volume is configured to contain or pass over the second surface of the photocatalyst coating facing the volume one or more reactants; and
a source of electromagnetic radiation which directs electromagnetic radiation either
i) through said substrate and said coating of said photocatalyst to catalyze a reaction of said one or more reactants, or
ii) through said volume to said coating of said photocatalyst to catalyze said reaction of said one or more reactants.

2. The reaction system of claim 1, wherein the photocatalyst comprises at least one chromophore having a sulfone or sulfur-containing cyclic moiety.

3. The reaction system of claim 1, wherein the photocatalyst comprises at least two different chromophores.

4. The reaction system of claim 1, wherein the substrate is a surface of a continuous flow reactor or a batch reactor.

5. The reaction system of claim 1, wherein the substrate is inserted into a continuous flow reactor or batch reactor.

6. The reaction system of claim 1, wherein the source of electromagnetic radiation comprises one or more of a semiconductor optical source, a light-emitting diode optical source, a compact fluorescent light source, an ultraviolet optical source, and a deep-ultraviolet optical source.

7. The reaction system of claim 1, wherein the photocatalyst further comprises one or more monomer units or derivative units obtained by post-polymerization functionalization having a functional group selected from the group consisting of silanes, siloxanes, nitriles, alkoxysilanes, chlorosilanes, dipodal silanes, catechols, urea derivatives, and epoxide derivatives.

8. A method of catalyzing a reaction, comprising:
exposing one or more reactants to a surface of a photocatalyst comprising non-conjugatively linked chromophores coated on a substrate; and
directing electromagnetic radiation either
i) through said substrate and said coating of said photocatalyst to cause said photocatalyst to catalyze a reaction between said one or more reactants, or
ii) through a volume containing said one or more reactants to said coating of said photocatalyst to catalyze said reaction between said one or more reactants.

9. The method of claim 8, wherein the photocatalyst comprises at least one chromophore having a sulfone or sulfur-containing cyclic moiety.

10. The method of claim 8, wherein the photocatalyst comprises at least two different chromophores.

11. The method of claim 8, wherein the substrate is a surface of a continuous flow reactor or a batch reactor.

12. The method of claim 8, wherein the substrate is inserted into a continuous flow reactor or batch reactor.

13. The method of claim 8, wherein the electromagnetic radiation is emitted from one or more of a semiconductor optical source, a light-emitting diode optical source, a compact fluorescent light source, an ultraviolet optical source, and a deep-ultraviolet optical source.

14. The method of claim 8, wherein the photocatalyst further comprises one or more monomer units or derivative units obtained by post-polymerization functionalization having a functional group selected from the group consisting of silanes, siloxanes, nitriles, alkoxysilanes, chlorosilanes, dipodal silanes, catechols, urea derivatives, and epoxide derivatives.

15. A photocatalyst having the following formula: 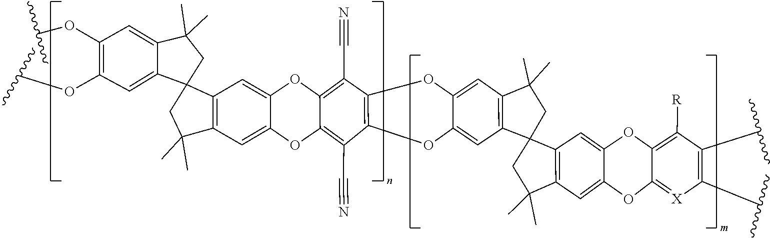
and isomers thereof wherein
X is selected from the group consisting of N, C—CN, and C—CF₃,
R is phenothiazine, phenoxazine, or an N-Aryl (5,10-dihydrophenazine derivative) group, and
n and m represent an integer that may be the same or different and wherein m is at least 1.

16. The photocatalyst of claim 15, wherein n is 2m.

17. The photocatalyst of claim 15, wherein m is 2n.

18. The photocatalyst of claim 15, further comprising one or more monomer units or derivative units obtained by post-polymerization functionalization having a functional group selected from the group consisting of silanes, siloxanes, nitrites, alkoxysilanes, chlorosilanes, dipodal silanes, catechols, urea derivatives, and epoxide derivatives.

19. The photocatalyst of claim 15, wherein the photocatalyst is coated on a substrate.

20. The photocatalyst of claim 19, wherein the substrate comprises glass.

21. A solution comprising the photocatalyst of claim 15, wherein the photocatalyst is dissolved in a solvent comprising N-methyl-2-pyrrolidone, chloroform, acetone, acetonitrile, dimethyl sulfoxide, water, aqueous sodium dodecyl sulfate, methylene chloride, or tetrahydrofuran.

22. A thin-film comprising the photocatalyst of claim 15.

23. A photovoltaic cell comprising the photocatalyst of claim 15.

24. An organic light emitting diode comprising the photocatalyst of claim 15.

25. A photocatalyst having the following formula: 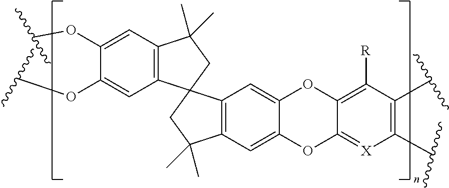
and isomers thereof, wherein
X is selected from the group consisting of N, C—CN, and C—CF₃,
R is selected from the group consisting of a sulfone, sulfur-containing cyclic moiety, a phenoxazine, an N-Aryl (5,10-dihydrophenazine derivative) group, a monoaryl amine, and a diary amine, and
n represents an integer of at least 1,
and wherein the photocatalyst does not include a terephthalonitrile-containing monomer.

26. The photocatalyst of claim 25, further comprising one or more monomer units or derivative units obtained by post-polymerization fractionalization having a functional group selected from the group consisting of silanes, siloxanes, nitriles, alkoxysilanes, chlorosilanes, dipodal silanes, catechols, urea derivatives, and epoxide derivatives.

27. The photocatalyst of claim 25, wherein the photocatalyst s coated on a substrate.

28. The photocatalyst of claim 27, wherein the substrate comprises glass.

29. A solution comprising the photocatalyst of claim 25, wherein the photocatalyst is dissolved in a solvent comprising N-methyl-2-pyrrolidone, chloroform, acetone, acetonitrile, dimethyl sulfoxide, water, aqueous sodium dodecyl sulfate, methylene chloride, or tetrahydrofuran.

30. A thin-film comprising the photocatalyst of claim 25.

31. A photovoltaic cell comprising the photocatalyst of claim 25.

32. An organic light emitting diode comprising the photocatalyst of claim 25.
